(19) United States
(12) Patent Application Publication
(10) Pub. No.: US 2025/0128249 A1
(43) Pub. Date: Apr. 24, 2025

(54) REGENERATION OF PLASTICS PYROLYSIS CATALYSTS

(71) Applicant: Anellotech, Inc., Pearl River, NY (US)

(72) Inventors: Zhihua Wu, Pearl River, NY (US); Torren Carlson, Pearl River, NY (US); Omar Basha, Wilmington, DE (US); Leslaw Mleczko, Dormagen, DE (US)

(21) Appl. No.: 18/491,797

(22) Filed: Oct. 22, 2023

(51) Int. Cl. B01J 38/60; B01J 29/40; B01J 38/68; C08J 11/16

(52) U.S. Cl. CPC B01J 38/60; B01J 29/40; B01J 38/68; C08J 11/16

(57) ABSTRACT

Methods and apparatus for the regeneration of catalysts used in catalytic pyrolysis of waste plastics, polymers, and other waste materials to useful chemical and fuel products such as paraffins, olefins, and aromatics such as BTX is described in which minerals are removed by washing to restore catalytic activity and selectivity. A catalytic pyrolysis process that includes the regeneration of a portion of the catalyst used for the catalytic pyrolysis with a washing process is described.

### FIELD OF THE INVENTION

This invention relates to methods and apparatus for the regeneration of catalysts used in catalytic pyrolysis of waste plastics, polymers, and other waste materials to useful chemical and fuel products such as paraffins, olefins, and aromatics such as BTX.

### INTRODUCTION

Plastic waste has become a considerable problem due to its buildup in landfills and the oceans. Both post-consumer plastic (PCP) and post-industrial plastic (PIP) contribute to the problem. The resistance to chemical or environmental breakdown that makes plastics so useful in our lives also makes waste plastics a nuisance since they don't decompose readily when discarded. A variety of recycling methods are being developed to return the material to useful forms, including mechanical and chemical methods. The mechanical recycling methods require relatively high purity materials or extensive cleanup. Chemical processes to recycle plastic waste are more tolerant to impurities although the impurities still must be removed before the products can re-enter the plastic cycle.

Plas-TCat™ is a catalytic fluid bed process using zeolite catalysts to chemically recycle polymer/plastic material, especially waste plastics that otherwise might be sent to a landfill or incinerator. The process is suitable for PCP and PIP that include polymers such as polyethylene (PE), polypropylene (PP), polystyrene (PS), polyvinylchloride (PVC), and polyethylene terephthalate (PET). The zeolite catalysts are microporous solid acid materials that are active for the upgrading of the primary products of plastics decomposition, converting them to a mixed product of permanent gases, C2-C4 light olefins, C1-C4 light paraffins, and C5+ hydrocarbons including benzene, toluene, and xylenes (BTX), aromatic and non-aromatic naphtha range molecules, C11+ hydrocarbons, coke and char, and minor byproducts.

When coke, char, and minerals build up on the catalysts, reducing activity and selectivity to useful products, they can be regenerated. Conventional means of regenerating catalysts from the catalytic pyrolysis of hydrocarbonaceous materials involve the combustion of carbonaceous materials that remain on the surface or in the pores of the catalyst, so that the catalyst can be returned to the pyrolysis reactor. Similar methods are used to regenerate catalysts from fluid cat cracking (FCC), hydrotreating (HT), and other refining or chemical processes.

Regeneration of catalysts that have been used to catalyze the pyrolysis of plastic presents new challenges due to the unique compositions and conditions that are utilized in catalytic pyrolysis of plastics. Waste plastics often include PVC or other materials that contain halogens, i.e. F, Cl, or Br, that must be removed to prohibit corrosion and to limit their concentration in the recycled products. A common technique for reducing the halogen content is to heat the plastic mixture with an absorbent material such as calcium oxide, calcium hydroxide, calcium carbonate, dolomite, or other materials that contain calcium such as red mud (a mixture of Fe2O3, Al2O3, SiO2, TiO2, Na2O, and CaO) or crushed oyster shells (largely CaCO3) in a dechlorination step prior to the catalytic upgrading step.

Calcium carbonate is the most common filler used in many polymeric materials to ease processing, improve mechanical properties, and reduce costs, so even without the absorbents added to remove chlorine, waste plastics often contain a significant fraction of calcium salts. Other common fillers include talc (Mg3Si4O10(OH)2), wollastonite (CaSiO3), and dolomite (CaMg(CO3)2), all of which bring Ca and/or Mg into the mixture.

Heating waste plastics in the presence of a calcium compound traps chlorine as CaCl2) so that the molten product mixture contains particles of CaCl2) and any unreacted CaO or CaCO3 or both. Filtration can remove some of these particulates, but inevitably fine particles are passed to any further processing step such as catalytic pyrolysis. During pyrolysis, the fine particles are deposited on the surface of the catalyst, where they block the surface sites that initiate polymer decomposition and block the pores, preventing reactants from reaching acidic active sites within the catalyst particle. The internal acidic sites catalyze the dehydrocyclization to aromatics and other catalytic reactions. The buildup of calcium compounds on the catalyst thus reduces activity and selectivity to aromatics and olefins. Although not as widely used as calcium, magnesium has a similar impact.

Compared to biomass pyrolysis, little attention has been paid to the problems that occur in the catalytic pyrolysis of plastics where the catalysts can be exposed to much greater amounts of calcium. Calcium in biomass is largely found as carboxylate salts that decompose with heat or acid, so that it is readily solubilized and removed from the process. By contrast, the inorganic calcium salts CaO, CaCO3, CaSO4, CaCl₂), etc. that are present in the plastics pyrolysis process are much less soluble and reactive so more severe processes are needed to remove them from the catalyst.

Daligaux et al. in “Deactivation and Regeneration of Zeolite Catalysts Used in Pyrolysis of Plastic Wastes—A Process and Analytical Review,” Catalysts, 2021, 11, 770 provide a review of processes for regenerating Zeolite catalysts used in the catalytic pyrolysis of plastic waste. Several oxidative processes are reviewed for removing coke from the catalyst. Zhou et al (US20150202615) describe a process for regenerating a catalyst by removing potassium using an ammonium solution wash. Results show that the removal of Ca or Mg was negligible, or in some cases Ca or Mg was increased by the washing process. In US Patent Application 20150004093 Zhou et al described using acids to improve pore volumes and surface areas of catalysts, but not to remove calcium or restore catalytic activity. Timken (US 20210332299) recognizes the problem caused by contaminants in plastic feeds and discloses a process for filtering and treating the oil resulting from pyrolysis with metal oxides to remove the contaminants. Catalyst regeneration is not discussed. Mazanec et al (US 20140303414) disclose a process for removing alkali and alkaline earth metals from catalysts used for catalytic biomass pyrolysis, and that calcium impregnated up to about 1.0 wt % does not significantly decrease aromatics yields in reactions of model oxygenates furan or furfural at 550° C. No disclosure of the removal of impurities from catalysts used in the catalytic pyrolysis of plastics or similar polymers was made. None of these references describe liquid solutions for removing metals deposited during the catalytic pyrolysis of plastics. A need exists for processes and apparatus to remove impurities, particularly minerals such as calcium, magnesium, and potassium, from catalysts used in plastics pyrolysis to extend catalyst life, improve selectivity to useful products like BTX, p-xylene, and olefins, and reduce costs while minimizing the impact on catalyst structure and composition and providing feeds for further processing that are compatible with existing infrastructure.

### SUMMARY OF THE INVENTION

In one aspect, this invention provides a method for regenerating a catalyst used in catalytic pyrolysis of plastics, comprising: providing a catalyst that has been used to catalyze a catalytic pyrolysis of plastics process; oxidatively regenerating the catalyst; washing at least a portion of the catalyst with a liquid wash solution; rinsing the washed catalyst with an aqueous solution; separating the catalyst from the rinse solution; and returning at least a portion of the separated catalyst to the process for the catalytic pyrolysis of plastics.

In any of its aspects, the invention can further characterized by one or any combination of the following:
the liquid wash solution used to wash the catalyst is selected from the groups consisting of: water, acidic water, water with surfactants, water with multi-dentate ligands (such as EDTA, polyvinlyalcohol, oxalic acid), alcohols, ethers, organic acids, amines, ammonium salts including ammonium nitrate, ammonium acetate, ammonium citrate, ammonium phosphate, or supercritical CO2, phosphoric acid, sulfuric acid, nitric acid, or some combination of these;
the liquid wash solution is an aqueous solution;
the wash solution comprises at least 90%, 95%, or at least 99% water;
the wash solution used to wash the catalyst comprises sulfuric acid;
the pH of the wash solution can be less than 5, 4, 3, 2, or 1, or from 0.01 to 5, 0.01 to 3, 0.1 to 2.5, or 0.1 to 2;
the pH of the wash solution used to wash the catalyst is less than 3;
the wash solution comprises sulfuric acid with a pH of less than 4, 3, 2, 1.5, or 1.1, or from 0.01 to 5, 0.01 to 3, 0.1 to 2.5, or 0.1 to 2;
the wash solution comprises 0.1 N sulfuric acid;
the catalyst is washed in a Soxhlet extractor, or similar apparatus;
the catalyst is washed in a co-current or countercurrent slurry bubble column reactor;
the catalyst is washed in a Pachuca tank or a settling tank;
the catalyst is washed in a compartmentalized slurry bubble column reactor;
the catalyst is washed in an inverse fluidized bed reactor;
the catalyst is introduced into the washing reactor as a solid or as a slurry;
the washing process is operated at a temperature of at least 15, 20, 35, 50, or 90° C., or from −20 to 200, from 20 to 100, or from 25 to 75° C.;
the temperature of the washing process is maintained at no more than 200° C., 150° C., 100° C., or 50° C., or in the range from 15 to 150° C., 15 to 100, 20 to 75, or 20 to 50° C.;
the chamber in which catalyst and wash solution are mixed is fitted with a cooling mechanism to prevent undesirable high temperatures;
the washing is conducted under pressure, with absolute pressures of at least 1.1, 2, 4, or 10 bara, or from 0.5 to 10, 0.9 to 4, or from 1 to 2 bara;
the minerals extracted into the liquid phase is recovered;
the process can include more than one washing step with the same wash solution or different wash solutions in each step;
the wash process is a batch process or a continuous process;
a continuous wash process is conducted with countercurrent flow of catalyst and wash solution in one vessel, or in multiple vessels wherein the catalyst and wash solutions move between vessels in a counter current fashion;
the average solids contact time in the vessel, defined as the bed height divided by the particles hindered settling velocity, is at least 20, 30, 40, 50, 60, 80 or from 40-60, 50-80, 80-100 minutes;
where the liquid to solids mass ratio in the washing vessel is at least 2, 3, 4, 5, 10 or from 2-5, 5-8 or 8-10;
the used wash solution is treated to remove at least a portion of the materials washed from the catalyst and the wash solution is recycled to a washing step;
the rinse solution is water, deionized water, distilled water, or an aqueous solution with less than 100 ppm of Ca and less than 100 ppm of Mg, or some combination thereof;
the rinse solution is any aqueous solution with less than 500, 400, 300, 200, 100, or 50 ppm Ca, or from 1 to 500, 10 to 200, 10 to 50, or 1 to 50 ppm Ca;
the rinse solution is any aqueous solution with less than 500, 400, 300, 200, 100, or 50 ppm Mg, or from 1 to 500, 10 to 200, or 10 to 50 ppm Mg;
the washed catalyst contains a lesser amount of one or more of the following elements Ca, Na, K, Ti or Mg, or combinations thereof after the washing step than were present prior to the washing step, wherein the percentage is based on the weight of liquid-free catalyst;
the washed catalyst may comprise at least 10%, 20%, 50%, or 80% less, or between 10 and 95% less, 10 and 90%, 10 and 80%, or between 10 and 50% less, all % by mass, of at least one of the elements selected from the group consisting of K, Ca, Na, Mg, Fe, Mn, S, Ti or combinations thereof, than does the catalyst prior to the washing step. In these comparisons, the weight (mass) does not include the weight of wash solution and the comparison is between unwashed and washed catalysts that have been calcined in air (oxidatively regenerated);
the K, Na, Ca, or Mg contents or their sum in the washed catalyst is greater than 2.0%, 1.0%, 0.6%, 0.3% 0.2%, 0.1%, 5000 ppm, 1000 ppm, or greater than 250 ppm by mass when expressed as oxides;
the K, Na, Ca, or Mg contents or their sum in the washed catalyst is less than 4.0%, 3.0%, 2.0%, 1.0%, 0.6%, 0.3%, 0.2%, 0.1%, 5000 ppm, 1000 ppm, or less than 250 ppm by mass when expressed as oxides;
the K, Na, Ca, or Mg contents or their sum in the washed catalyst is in the range from 1 ppm to 3.0%, 10 ppm to 2.0%, 100 ppm to 2.0%, 0.01% to 1.5%, 0.1% to 1.5%, or 0.1% to 4.0% by mass when expressed as oxides;
the K, Ca, Ti, or Mg contents or their sum in the catalyst prior to washing is at least 10%, 8%, 5%, 4.0%, 3.0%, 2.0%, 1.0%, 0.6%, 0.3%, 0.2%, 0.1%, 5000 ppm, 1000 ppm, or at least 250 ppm by mass when expressed as oxides. The K, Ca, Ti, or Mg contents or their sum in the catalyst prior to washing is in the range from 0.1% to 10%, 0.2% to 8%, 0.5% to 5%, or 1% to 5% by mass when expressed as oxides;
the washed catalyst may have at least 10%, 20%, 50%, or 80% less calcium, or from 10 to 95%, 10 to 90%, 10 to 80%, 30 to 70%, or 40 to 65% less calcium by weight than does the catalyst prior to the washing step, where the mass % is measured for catalysts after calcination expressed as oxides;
the washed catalyst may have at least 3%, 5%, 8%, 10%, 20%, or 25% less magnesium, or from 1 to 50%, 5 to 40%, 2 to 35%, or 10 to 30% less magnesium by weight than does the catalyst prior to the washing step, where the mass % is measured as oxides for catalysts after calcination; the sum of Al₂O₃, SiO₂, and TiO₂ wt % is at least 70, 75, 80, 82, or from 75 to 90, 80 to 88, or 82 to 85 wt % of the calcined and washed catalyst;
the sum of Al₂O₃, SiO₂, and TiO₂ wt % in the washed catalyst is less than 5%, 3%, 2%, 1.5%, or 1.0% different from, i.e., either larger or smaller than, the sum of Al₂O₃, SiO₂, and TiO₂ wt % in the fresh catalyst, where the mass % is measured for catalysts after calcination;
the sum of Al₂O₃, SiO₂, and TiO₂ wt % in the washed catalyst is from 0.001 to 5%, 0.01 to 3%, 0.01 to 2%, 0.01 to 1.5%, or 0.01 to 1.0% different from, i.e., either larger or smaller than, the sum of Al₂O₃, SiO₂, and TiO₂ wt % in the fresh catalyst, where the mass % is measured for catalysts after calcination;
the washed catalyst can have at least 30%, 40%, 50%, 60%, 70%, 80%, or 90%, or less than 150%, 140%, or 135%, or from 30% to 175%, 50% to 150%, 70% to 150%, or from 80% to 140% of the Brønsted acid site density (mmol/kg) as compared to a freshly prepared catalyst; Unless described otherwise, Brønsted acid sites are determined by deconvoluting the IPA-TPD trace as shown in the examples. The term “a freshly prepared catalyst” refers to the catalyst that has not been regenerated and is in the state that it is added to a plastics pyrolysis reactor.

The Brønsted acid site density (mmol/kg) of the catalyst may increase at least 15%, 20%, 25%, 30%, or 40%, or from 1% to 75%, 10% to 70%, or 20% to 60% after washing compared to the Brønsted acid site density of the catalyst before washing;
the Brønsted acid site density (mmol/kg) of the catalyst after washing is at least 30, 40, 50, 60, 70, 75, 80, 85, 90, 95, 100, or 110, or from 30 to 150, 70 to 140, or from 80 to 120 mmol/kg as measured by an IPA-TGA adsorption experiment;
the portion of the oxidatively regenerated catalyst sent to the wash is only a portion, such as 0.1 to 10%, 1 to 50%, 2 to 40%, 5 to 35%, or 10 to 30%, or less than 50%, 25%, 10%, 5%, or less than 1%, of the oxidatively regenerated catalyst;
the catalyst could be washed after it has passed through the reactor many times and oxidatively regenerated, i.e., washed after the mass ratio of waste plastic processed to catalyst inventory has exceeded 4, 10, 25, or 35, or from 1 to 100, 4 to 70, or 10 to 40 during it use in the catalytic plastic pyrolysis process;
the wash process may be operated intermittently, i.e. not during the entire time of the plastics upgrading process, but only during specific time periods, during which time the washing process is operated as a continuous process and at other times the washing process is not operated; the washed catalyst can be separated from the wash solution or rinse solution by a process comprising one or more filtration steps;
the washed catalyst can be separated from the wash solution or rinse solution by a process comprising one or more centrifugal steps such as a hydrocyclone, or a centrifugal decanter; the sum of the aromatics and olefins yields in wt % may increase at least 3%, 9%, 13%, 20%, or 25%, after washing the catalyst compared to the sum of the aromatics and olefins yields for the unwashed catalyst, as tested by reacting plastic with a sample of catalyst in a fixed bed reactor at a temperature of at least 500° C.;
the aromatics wt % yield may increase by at least 30%, 40%, 50%, or 65%, or from 20% to 80%, 40% to 70%, or 50% to 70% after washing the catalyst compared to the aromatics yield for the unwashed catalyst, as tested by reacting plastic with a sample of catalyst in a fixed bed reactor at a temperature of at least 500° C.;
the BTX wt % yield may increase by at least 50%, 70%, 100%, 150%, or 170%, or from 50% to 300%, 60% to 250%, or 70% to 200% after washing the catalyst once compared to the BTX yield for the unwashed catalyst, as tested by reacting plastic with a sample of catalyst in a fixed bed reactor at a temperature of at least 500° C.;
the BTX yield after washing is at least 25, 30, 35, or 40%, or from 25 to 50, 25 to 45, or 25 to 40% by mass based on plastic feed;
the xylenes wt % yield may increase by at least 50%, 60%, 100%, 200%, or 400%, or from 50% to 700%, 60% to 500%, or 70% to 200% after washing the catalyst once compared to the xylenes yield for the unwashed catalyst, as tested by adding plastic to a sample of catalyst in a fixed bed reactor at a temperature of at least 500° C.;
the yield of xylenes is at least 2, 3, 3.5, 4.0, 4.5, 5.0, or 5.5, or from 3 to 6.5, 3.5 to 6.0, or 3.0 to 5.5% by mass based on plastic feed as tested by adding plastic to a sample of catalyst in a fixed bed reactor at a temperature of at least 500° C.;
the selectivity for xylenes among BTX products is returned to the selectivity measured after less than 20 hours on stream by washing the catalyst;
the selectivity for xylenes among BTX products is greater than 5, 8, 10, 11, or 12% by mass after washing the catalyst that has been on stream for at least 10 hours or the catalyst has processed a mass of plastic that is at least 0.79 times the mass of catalyst in the reactor;
the wash process that is effective at removing Ca, removing Mg, improving aromatics yield, improving BTX yield, improving xylenes yield, or regenerating Bronsted acid site density, or some combination of these, is operated after the mass ratio of waste plastic processed to catalyst inventory has exceeded 4, 10, 25, or 35, or from 1 to 100, 4 to 70, or 10 to 40 during the course of the catalytic plastic pyrolysis process operation;
the catalyst is stripped of volatile carbonaceous deposits by passing a stream of steam over the catalyst before it is oxidatively regenerated;
the catalyst removed from the reactor is oxidatively regenerated by contact with an oxygen-containing gas or other oxidant;
the oxidant for the oxidative regeneration may comprise oxygen, air, oxygen-enriched air, steam, or CO2 or some combination of these;
prior to the step of washing the catalyst, the catalyst removed from the catalytic pyrolysis reactor is combusted with oxygen in the presence of steam;
the step of reacting with an oxidant is conducted at a temperature of at least 550° C., 575° C., 600° C., 625° C., or 650° C., or from 500° C. to 700° C., 500° C. to 650° C., 500° C. to 600° C., 550° C. to 700° C., 550° C. to 650° C., 575° C. to 650° C., or 600° C. to 650° C., or less than 750° C., 700° C., 675° C., or 650° C.;
the catalyst that is contacted with the oxidant may contain at least 0.1%, 0.2%, 0.5%, 1.0%, 1.5%, 2.0%, or at least 2.5% by weight carbon, or from 0.1 to 3%, 0.2 to 2.5%, or 0.5 to 2% by weight carbon based on the total weight of catalyst including any contaminants;
the oxidatively regenerated and washed catalyst has a lower percentage of carbon by mass than the catalyst removed from the catalytic pyrolysis reactor;
at least a portion of the catalyst that has been treated with an oxidant is passed through one or more cyclones to separate the catalyst from ash and/or catalyst fines;
the step of reacting with an oxidant is conducted prior to the step of washing;
the step of reacting with an oxidant is conducted after the step of washing;
at least a portion of hot flue gas from the regeneration (oxidation) process may be used to heat the catalytic pyrolysis reactor;
at least a portion of hot flue gas from the regeneration (oxidation) process may be recycled back to fluidize the regenerator vessel;
the process may comprise treating the washed catalyst with a solution that adds one or more metals or other elements to the catalyst to restore catalyst activity or stability; elements added to the washed catalyst may include P, Fe, Ga, Zn, or La or some combination thereof;
prior to the step of oxidatively regenerating the catalyst, the catalyst removed from the catalytic pyrolysis reactor is stripped of volatile materials by passing a stream comprising steam through the catalyst and collecting the products;
at least a portion of the oxygen-containing gas that exits from the combustion zone is recycled back into the combustion zone;
at least a portion of the hot flue gas from the combustion zone is used to heat the catalytic pyrolysis reactor;
the step of reacting used catalyst with an oxidant results in a hot regenerated catalyst that is separated from ash and/or catalyst fines before being subjected to the washing step; catalyst that has been washed with wash solution is separated from the wash solution or rinse solution and at least a portion of the separated catalyst is added to the reactor for the catalytic pyrolysis of plastic;
the carbon content of the oxidatively regenerated catalyst is less than 2.0%, 1.5%, 1.0%, 0.6%, 0.3% 0.2%, 0.1%, 5000 ppm, 1000 ppm, or less than 250 ppm;
the carbon content of the oxidatively regenerated catalyst is greater than 1.0%, 0.6%, 0.3% 0.2%, 0.1%, 5000 ppm, 1000 ppm, or greater than 250 ppm, or in the range from 100 ppm to 2.0%, 0.1% to 1.5%, 0.1% ppm to 1.0%, or 0.2% to 1.0%;
the process may comprise the conversion of plastics to hydrocarbon products, comprising feeding plastics into a reactor, pyrolyzing the plastics in the reactor in the presence of a catalyst that catalyzes the pyrolysis reaction which results in coke-contaminated catalyst;
the residence time of gases or feed molecules in the catalytic pyrolysis reactor is at least 0.1 seconds, 0.3, 0.5, 1, 2, 3, 5, or 10 seconds, or in the range of 0.3 to 30, 2 to 15, 5 to 15, 2 to 5, 10 to 30, or 0.5 to 10 seconds;
the temperature in the catalytic pyrolysis reactor where catalyst is present is in the range of 500 to 700° C., 520 to 600° C., 500 to 575° C., 550 to 600° C., 575 to 625° C., or 540 to 580° C. the pressure in the catalytic pyrolysis reactor is at least 1.1, 2, 4, or 10 bara, or from 0.5 to 10, 0.9 to 4, or from 1 to 2 bara;
the catalyst is a fluid bed catalyst;
the catalyst may comprise a zeolite;
the catalyst may comprise ZSM-5, ferrierite, zeolite Y, zeolite beta, mordenite, MCM-22, ZSM-23, ZSM-57, SUZ-4, EU-1, ZSM-11, (S)AlP0-31, SSZ-23, WOx/ZrO2, aluminum phosphates or some combination thereof;
the catalyst may comprise a promoter chosen from among nickel, palladium, platinum, titanium, vanadium chromium, manganese, iron, cobalt, zinc, copper, gallium, phosphorus, the rare earth elements, i.e., elements 57-71, cerium, zirconium, or any of their oxides or some combination thereof;
the catalytic pyrolysis is conducted in a fluidized bed reactor;
the catalytic pyrolysis is conducted in a bubbling bed reactor;
the catalyst may undergo a calcination step before being returned to the reactor;
the water content in the washed catalyst returned to the reactor is less than 15%.

The invention includes a process for regenerating a catalyst by introducing an oxygen-containing regeneration gas and coke-contaminated fluid bed catalyst into a dilute phase combustion zone maintained at a temperature sufficient for coke oxidation and therein oxidizing coke to produce hot regenerated catalyst and hot flue gas; transporting said hot flue gas and said hot regenerated catalyst from said combustion zone into a regenerated catalyst disengaging zone, wherein said hot regenerated catalyst is separated from said flue gas; and transporting a portion of said hot regenerated catalyst from said disengaging zone to the catalyst feed hopper of a fluid bed catalytic pyrolysis reactor.

The invention also includes apparatus and systems (which include apparatus, chemical compositions and/or conditions within apparatus).

The invention provides an apparatus for oxidatively regenerating a coke-contaminated, fluid catalyst, which apparatus comprises: a combustion chamber having an inlet for coke-contaminated pyrolysis catalyst, an inlet for an oxidizing regeneration gas connecting with the combustion chamber, an outlet for flue gas, a solid-vapor separation device for separating solids from the flue gas, and an outlet for regenerated catalyst; a disengagement chamber having an inlet that is connected to the outlet of the combustion chamber; a heat exchange conduit containing heat absorbing material positioned within the combustion chamber adapted to remove heat from the combustion chamber, the conduits being sealed with respect to the interior of the combustion chamber such that the heat-absorbing material is in indirect heat exchanging contact with the interior of the combustion chamber; and a washing chamber adapted to receive the regenerated catalyst.

The one or more washing chambers each comprises a tank or vessel having an inlet for the solids and an inlet for the wash solution, wherein the solids and wash solution are contacted. The washing chamber can be operated in a batch or preferably in a continuous manner. The washing chamber may be a slurry bubble column operated in the turbulent or the heterogeneous (growing bubble) regime. The washing chamber may be compartmentalized or include internals to control mixing and/or solids and liquid dispersion. When operated in a continuous manner the wash chamber contains apparatus for collecting the solids such as a filter, screen, mesh, sieve, solid bowl decanter centrifuge, or other mechanism or structure known to those skilled in the art by which the solids are separated from the wash solution and removed from the chamber, and an exit conduit for the spent wash solution. In this disclosure solutions are liquid phase solutions.

The invention also provides systems or methods comprising the apparatus which maintains the time-averaged maximum or transient maximum temperature in the catalyst regenerator at a temperature of at least 550° C., 575° C., 600° C., 625° C., or 650° C., or from 500° C. to 700° C., 500° C. to 650° C., 550° C. to 700° C., 550° C. to 650° C., 575° C. to 650° C., or 600° C. to 650° C., or less than 750° C., 700° C. or 675° C. Preferably, the catalyst regenerator comprises a fluidized bed reactor adapted so that the regeneration gas inlet provides at least a portion of the fluidization gas.

In preferred embodiments of the invention: the catalyst is in the form of particles; the pyrolysis of plastic is conducted in a fluidized bed reactor. Preferably, the catalyst comprises a zeolite. In some embodiments, the invention provides a catalyst for the catalytic pyrolysis of plastic wherein element or elements deposited on the catalyst during the pyrolysis reaction have been at least partially, but not completely removed, for example, comprising deposited elements that comprise at least 10%, 8%, 5%, 4.0%, 3.0%, 2.0%, 1.0%, 0.6%, 0.3%, 0.2%, 0.1%, 5000 ppm, 1000 ppm, or at least 250 ppm by mass, or in the range from 0.1% to 10%, 0.2% to 8%, 0.5% to 5%, or 1% to 5% of the total mass of catalyst plus contaminants when expressed as oxides. The invention includes intermediates such as the catalyst that has been washed with a wash solution.

We have surprisingly found that catalyst can be successfully used for the catalytic pyrolysis of plastic where a significant percentage of contaminants remain on the catalyst after washing. Thus, the invention includes processes, apparatus, systems, and catalysts wherein the catalyst retains calcium deposited on the catalyst during exposure to plastic and is not fully removed, i.e., the calcium content of the washed catalyst may be may be greater than 1.0%, 0.6%, 0.3% 0.2%, 0.1%, 5000 ppm, 1000 ppm, or greater than 250 ppm, or in the range from 1 ppm to 2.0%, 1 ppm to 1.0%, 10 ppm to 0.6%, 100 ppm to 0.3%, 250 ppm to 0.2%, 100 to 5000 ppm, 100 to 1000 ppm, or 10 to 250 ppm by mass. Also, the carbon content of the oxidatively regenerated and washed catalyst may be greater than 1.0%, 0.6%, 0.3% 0.2%, 0.1%, 5000 ppm, 1000 ppm, or greater than 250 ppm, or in the range from 100 ppm to 2.0%, 0.1% to 1.5%, 0.1% ppm to 1.0%, or 0.2% to 1.0%.

The invention also includes recovery of minerals and mineral solutions. For example, the invention includes a solution obtained by washing a used calcined catalytic pyrolysis catalyst with water or other solvent to generate a solution comprising K, Ca, Mg, Si, Ga, Zn, Co, Fe, Cr, Cu, V, Ni, Mn, Ag, Na, P, Sn, Zr, Nb, Y, Ti, Ce, La, or combinations thereof; as well as minerals recovered from this solution. The invention includes a process for recovering minerals from the catalytic pyrolysis of plastic, comprising separating dissolved solids from any of the solutions.

This invention further provides a method for regenerating a coke contaminated catalytic pyrolysis catalyst by contacting the catalyst with an oxidizing gas in a fluidized bed or other regenerator, separating the regenerated catalyst from the flue gas, washing a portion of the separated catalyst, and returning at least a portion of the regenerated and washed catalyst to the catalyst feed hopper of the catalytic pyrolysis reactor. In the method for regenerating a coke and minerals contaminated catalytic pyrolysis catalyst, the process includes the steps of: (1) introducing oxidizing regeneration gas and coke-contaminated catalyst into a combustion zone maintained at a temperature sufficient for coke oxidation and therein oxidizing coke to produce hot regenerated catalyst and hot flue gas; (2) transporting at least a portion of the hot flue gas and at least a portion of the hot regenerated catalyst from the combustion zone into a regenerated catalyst disengaging zone, wherein the hot oxidatively regenerated catalyst is separated from the flue gas; (3) transporting at least a portion of the separated catalyst from the disengaging zone to a catalyst washing zone and contacting the catalyst with a wash solution, and (4) separating the washed catalyst from the wash solution and returning it to the fluid bed catalytic pyrolysis reactor.

In another embodiment the process includes the steps of (1) treating a partially deactivated catalyst with a steaming/stripping gas, (2) introducing oxidizing regeneration gas and the steamed/stripped coke-contaminated catalyst into a combustion zone maintained at a temperature sufficient for coke oxidation and therein oxidizing coke to produce hot regenerated catalyst and hot flue gas; (3) transporting at least a portion of the hot flue gas and at least a portion of the hot regenerated catalyst from the combustion zone into a regenerated catalyst disengaging zone, wherein the hot regenerated catalyst is separated from the flue gas; (4) transporting a portion of the separated catalyst from the disengaging zone to a catalyst washing zone and contacting the catalyst with a wash solution, and (5) separating the washed catalyst from the wash solution and returning it to the fluid bed catalytic pyrolysis reactor.

In another embodiment, the process provides a method of converting plastics to hydrocarbon products, comprising: feeding plastics into a reactor fitted with a catalyst; pyrolyzing the plastics in the reactor in the presence of a catalyst that catalyzes the pyrolysis reaction which results in coke-contaminated catalyst; removing a portion of the catalyst from the reactor; oxidatively regenerating the catalyst; washing the catalyst with a wash solution; rinsing the catalyst with an aqueous solution; separating the catalyst from the rinse solution; and returning at least a portion of the separated catalyst to the process for the catalytic pyrolysis of plastics.

In any of the inventive embodiments, optionally, gas from the combustion chamber(s) can be used elsewhere in a plastics upgrading process, preferably by heating a pyrolysis reactor or recycled into the combustion chamber or used in the thermal pretreatment of plastic. In some embodiments the catalyst regeneration process comprises more than one combustion chamber in series or in a single combustion chamber but at two different temperatures.

### Glossary

Aromatics—As used herein, the terms “aromatics” or “aromatic compound” are used to refer to a hydrocarbon compound or compounds comprising one or more aromatic groups such as, for example, single aromatic ring systems (e.g., benzyl, phenyl, etc.) and fused polycyclic aromatic ring systems (e.g. naphthyl, 1,2,3,4-tetrahydronaphthyl, etc.). Examples of aromatic compounds include, but are not limited to, benzene, toluene, indane, indene, 2-ethyl toluene, 3-ethyl toluene, 4-ethyl toluene, trimethyl benzene (e.g., 1,3,5-trimethyl benzene, 1,2,4-trimethyl benzene, 1,2,3-trimethyl benzene, etc.), ethylbenzene, styrene, cumene, methylbenzene, propylbenzene, xylenes (e.g., p-xylene, m-xylene, o-xylene, etc.), naphthalene, methyl-naphthalene (e.g., 1-methyl naphthalene, anthracene, 9,10-dimethylanthracene, pyrene, phenanthrene, dimethyl-naphthalene (e.g., 1,5-dimethylnaphthalene, 1,6-dimethylnaphthalene, 2,5-dimethylnaphthalene, etc.), ethyl-naphthalene, hydrindene, methyl-hydrindene, and dymethyl-hydrindene. Single-ring and/or higher-ring aromatics may also be produced in some embodiments.

Catalysts—Catalyst components useful in the context of this invention can be selected from any catalyst known in the art, or as would be understood by those skilled in the art. Catalysts promote and/or affect reactions. Thus, as used herein, catalysts lower the activation energy (increase the rate) of a chemical process, and/or improve the distribution of products or intermediates in a chemical reaction (for example, a shape-selective catalyst). Examples of reactions that can be catalyzed include dehydration, dehydrogenation, isomerization, hydrogen transfer, aromatization, decarbonylation, decarboxylation, aldol condensation, and combinations thereof. Catalyst components can be considered acidic, neutral or basic, as would be understood by those skilled in the art.

For catalytic pyrolysis, particularly advantageous catalysts include those containing internal porosity selected according to pore size (e.g., mesoporous and pore sizes typically associated with zeolites), e.g., average pore sizes of less than about 100 Angstroms, less than about 50 Angstroms, less than about 20 Angstroms, less than about 10 Angstroms, less than about 5 Angstroms, or smaller. These are often called molecular sieves. In some embodiments, catalysts with average pore sizes of from about 5 Angstroms to about 100 Angstroms may be used. In some embodiments, catalysts with average pore sizes of between about 5.5 Angstroms and about 6.5 Angstroms, or between about 5.9 Angstroms and about 6.3 Angstroms may be used. In some cases, catalysts with average pore sizes of between about 7 Angstroms and about 8 Angstroms, or between about 7.2 Angstroms and about 7.8 Angstroms may be used. In some preferred embodiments of catalytic pyrolysis, the catalyst may be selected from naturally occurring zeolites, synthetic zeolites and combinations thereof. In certain embodiments, the catalyst may be a ZSM-5 zeolite catalyst, as would be understood by those skilled in the art. Optionally, such a catalyst can comprise acidic sites. Other types of zeolite catalysts include: ferrierite, zeolite Y, zeolite beta, mordenite, MCM-22, ZSM-23, ZSM-57, SUZ-4, EU-1, ZSM-11, (S)AlP0-31, SSZ-23, among others. In other embodiments, non-zeolite catalysts may be used; for example, WOx/ZrO2, aluminum phosphates, etc. In some embodiments, the catalyst may comprise a metal and/or a metal oxide. Suitable metals and/or oxides include, for example, nickel, palladium, platinum, titanium, vanadium chromium, manganese, iron, cobalt, zinc, copper, gallium, and/or any of their oxides, among others. In some cases promoter elements chosen from among phosphorus, the rare earth elements, i.e., elements 57-71, cerium, zirconium or their oxides for combinations of these may be included to modify activity or structure of the catalyst. In addition, in some cases, properties of the catalysts (e.g., pore structure, type and/or number of acid sites, etc.) may be chosen to selectively produce a desired product.

Catalysts may be characterized by a concentration of Brønsted acid sites. Unless described otherwise, Brønsted acid sites are determined by deconvoluting the IPA-TPD trace. The term “a freshly prepared catalyst” refers to a catalyst that has not been regenerated and is in the state that it is added to a plastics pyrolysis reactor.

The molecular sieves may be used as the catalytic pyrolysis catalyst without any binder or matrix, in a self-bound form. Alternatively, the molecular sieves may be composited with another material that is resistant to the temperatures and other conditions employed in the pyrolysis reaction. Such binder or matrix materials include active and inactive materials and synthetic or naturally occurring zeolites as well as inorganic materials such as clays and/or oxides such as alumina, silica, silica-alumina, zirconia, titania, magnesia, or mixtures of these and other oxides. The latter may be either naturally occurring or in the form of gelatinous precipitates or gels comprising mixtures of silica and metal oxides. Clays may also be included with the oxide binders to modify the mechanical properties of the catalyst or to assist in its manufacture. The relative proportions of molecular sieve and binder matrix vary widely, with the sieve content ranging from 1 wt % to 90 wt %. In some embodiments, the composite is prepared in the form of fluidizable particles.

Coke—Coke is the carbonaceous material that is deposited on a catalyst during the pyrolysis reaction by the decomposition of hydrocarbonaceous materials. The carbon content of coke is typically at least 80%, and it contains smaller amounts of hydrogen and other heteroatoms (O, Cl, S, N, Br, etc.). The word ‘carbon’ is sometimes used to indicate coke-like carbon deposits.

Contact Time—Contact time is the residence time of a material in a reactor or other device, when measured or calculated under standard conditions of temperature and pressure, i.e., 0° C. and 1 atm. For example, a 2-liter reactor to which is fed 3 standard liters per minute of gas has a contact time of ⅔ minute, or 40 seconds for that gas. For a chemical reaction, contact time or residence time is based on the volume of the reactor, where substantial reaction is occurring, and would exclude volume where substantially no reaction is occurring, such as an inlet or an exhaust conduit. For catalyzed reactions, the volume of a reactor is the volume where catalyst is present.

Conversion—The term “conversion of a reactant” refers to the reactant mole or mass change between a material flowing into a reactor and a material flowing out of the reactor divided by the moles or mass of reactant in the material flowing into the reactor. For example, if 100 grams of ethylene are fed to a reactor and 30 grams of ethylene are flowing out of the reactor, the conversion is [(100−30)/100]=70% conversion of ethylene.

Fluid—The term “fluid” refers to a gas, a liquid, a mixture of a gas and a liquid, or a gas or a liquid containing dispersed solids, liquid droplets and/or gaseous bubbles. The terms “gas” and “vapor” have the same meaning and are sometimes used interchangeably. In some embodiments, it may be advantageous to control the residence time of the fluidization fluid in the reactor. The fluidization residence time of the fluidization fluid is defined as the volume of the reactor divided by the volumetric flow rate of the fluidization fluid under process conditions of temperature and pressure.

Fluidized Bed Reactor—The term “fluidized bed reactor” is given its conventional meaning in the art and is used to refer to reactors comprising a vessel that can contain a granular solid material (e.g., silica particles, catalyst particles, etc.), in which a fluid (e.g., a gas or a liquid) is passed through the granular solid material at velocities sufficiently high as to suspend the solid material and cause it to behave as though it were a fluid. Examples of fluidized bed reactors are described in “Fluidization Engineering” by D. Kunii and O. Levenspiel, Butterworth-Heinemann, 1991, incorporated herein by reference.

Bubbling fluidized bed reactors and turbulent fluidized bed reactors are known to those skilled in the art. In bubbling fluidized bed reactors, the fluid stream used to fluidize the granular solid material is operated at a sufficiently low flow rate such that bubbles and voids are observed within the volume of the fluidized bed during operation. In turbulent fluidized bed reactors, the flow rate of the fluidizing stream is higher than that employed in a bubbling fluidized bed reactor, and hence, bubbles and voids are not observed within the volume of the fluidized bed during operation. Examples of circulating, bubbling, and turbulent fluidized bed reactors are described in Kirk-Othmer Encyclopedia of Chemical Technology (online), Vol. 11, Hoboken, N.J.: Wiley-Interscience, 2001, pages 791-825, incorporated herein by reference.

Plastics or Polymers—The terms “plastics” and “polymers” are used interchangeably herein. A polymer is a carbon-based (at least 50 mass % C) material chiefly made up of repeating units and having a number average molecular weight of at least 100, typically greater than 1000 or greater than 10,000. Polymers include thermoplastic polymers such as, for example, polyethylene, polypropylene, polyesters, polyethylene terephthalate (PET), acrylonitrile-butadiene-styrene (ABS) copolymers, polyamide, polyurethane (PU), polyethers, polycarbonates (PC), poly(oxides), poly(sulfides), polyarylates, polyetherketones, polyetherimides, polysulfones, polyurethanes, polyvinyl alcohols, and polymers produced by polymerization of monomers, such as, for example, dienes, olefins, styrenes, acrylates, acrylonitrile, methacrylates (MMA), methacrylonitrile, diacids and diols, lactones, diacids and diamines, lactams, vinyl halides, vinyl esters, block copolymers thereof, and alloys thereof, thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; and blends thereof. Mixtures of polymers separated from municipal solid waste or other waste streams are suitable feeds provided they contain only small fractions of contaminants such as S, N, O, or halogens. Polymers yielding halogenated material upon pyrolysis, for example, polyvinyl chloride (PVC), polytetrafluoroethylene (PTFE), and other halogenated polymers, are generally minimized or excluded from the feed materials useful in this invention.

Pretreatment—The term “pretreatment” as used herein comprises any of the processes that are conducted to prepare the waste plastics for use in a catalytic pyrolysis or other upgrading process. Some of the processes that can be part of a pretreatment process include: 1) separating or grading by type of material, which selectively removes some materials that are not desirable and serves to make the feed mixture more homogeneous, 2) washing, which can include solvent or water or aqueous solution treatment to remove dirt, organic material clinging to the plastics, labels, or the like, 3) drying, which is the removal of water or other solvents or volatile materials, 4) sizing, which means cutting or comminuting or reducing the dimensions of larger particles into sizes more amenable to further processing, 5) contaminant removal, which can be a thermal or chemical or both thermal and chemical treatment that results in a reduction of the concentration of elements other than carbon and hydrogen, particularly removal of halides F, Cl, Br, or I, nitrogen, oxygen, sulfur, or metals, or a combination of these elements. Pretreatment processes may comprise any process selected from among collecting, separating, mixing, contaminant removal, dechlorination, dehalogenation, desulfurization, distilling, oxidizing, hydrotreating, pyrolyzing, washing, sizing, melting, pelleting, filtering, drying, or combinations thereof.

Pyrolysis—The terms “pyrolysis” and “pyrolyzing” are given their conventional meaning in the art and are used to refer to the transformation of a compound, e.g., a solid hydrocarbonaceous material, into one or more other substances, e.g., volatile organic compounds, gases, and coke, by heat, preferably without the addition of, or in the absence of, O2. Preferably, the volume fraction of 02 present in a pyrolysis reactor is 0.5% or less. Pyrolysis may take place with or without the use of a catalyst. “Catalytic pyrolysis” refers to pyrolysis performed in the presence of a catalyst and may involve steps as described in more detail below. Examples of catalytic pyrolysis processes are outlined, for example, in Huber, G. W. et al, “Synthesis of Transportation Fuels from Biomass: Chemistry, Catalysts, and Engineering,” Chem. Rev. 106, (2006), pp. 4044-4098.

Selectivity—The term “selectivity” refers to the amount of production of a particular product in comparison to a selection of products. Selectivity to a product may be calculated by dividing the amount of the particular product by the amount of a number of products produced. For example, if 75 grams of aromatics are produced in a reaction and 20 grams of benzene are found in these aromatics, the selectivity to benzene amongst aromatic products is 20/75=26.7%. Selectivity can be calculated on a mass basis, as in the aforementioned example, or it can be calculated on a carbon basis, where the selectivity is calculated by dividing the amount of carbon that is found in a particular product by the amount of carbon that is found in a selection of products. Unless specified otherwise, for reactions involving plastics as a reactant, selectivity is on a mass basis. For reactions involving conversion of a specific molecular reactant (ethene, for example), selectivity is the percentage (on a mass basis unless specified otherwise) of a selected product divided by all the products produced.

The term “yield” is used herein to refer to the amount of a product flowing out of a reactor divided by the amount of reactant flowing into the reactor, usually expressed as a percentage or fraction. Yields are often calculated on a mass basis, carbon basis, or on the basis of a particular feed component. Mass yield is the mass of a particular product divided by the weight of feed used to prepare that product. For example, if 500 grams of plastic is fed to a reactor and 45 grams of benzene is produced, the mass yield of benzene would be 45/500=9% benzene. Carbon yield is the mass of carbon found in a particular product divided by the mass of carbon in the feed to the reactor. For example, if 500 grams of plastic that contains 80% carbon is reacted to produce 350 grams of benzene that contain 92.3% carbon, the carbon yield is [(50*0.923)/(500*0.80)]=11.5%. Carbon yield from plastic is the mass of carbon found in a particular product divided by the mass of carbon fed to the reactor in a particular feed component. Yields may be measured in batch experiments where a sample of plastic is added to a sample of catalyst at a temperature greater than 500° C. and the products are measured, as in the drop tube experiments described herein.

As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of.” As used in this specification, the terms “includes” or “including” should not be read as limiting the invention but, rather, listing exemplary components. As is standard terminology, “systems” include to apparatus and materials (such as reactants and products) and conditions within the apparatus.

### BRIEF DESCRIPTION OF THE FIGURES

FIG. 1. presents a schematic of one embodiment of the catalyst regeneration sequence for catalytic plastics pyrolysis.

FIG. 2 presents one embodiment of a pretreatment process for preparing plastics.

FIG. 3 depicts an embodiment of a process for pretreating and upgrading plastic mixtures.

FIG. 4 shows a ‘drop-tube’ reactor for testing catalyst activity.

### DETAILED DESCRIPTION

It is an object of the present invention to propose a process for regenerating catalytic plastics pyrolysis catalysts by optionally steaming or stripping to remove adsorbed organic materials, removing the carbon by partial combustion, and removing excess mineral materials by washing with water, dilute acid solutions, or solvent mixtures, and optionally re-introducing active metals into the catalyst.

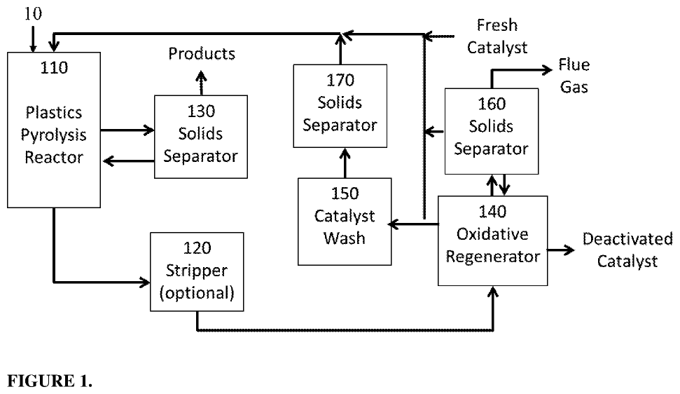

FIG. 1 shows a schematic of one embodiment of a process for producing useful products from waste plastics in which plastics pyrolysis catalysts are regenerated according to the present invention. A stream of mixed waste plastics 10 is introduced into a plastics catalytic pyrolysis reactor 110 comprising a fluidized bed of catalyst. Carried along with the plastics are small amounts of inorganic elements comprising Ca and optionally other minor components such as K, Na, Fe, Mg, Ti and other materials. In the pyrolysis reactor, the plastics are pyrolyzed and catalytically converted into permanent gases, C2-C4 light olefins, C1-C4 light paraffins, and C5+ hydrocarbons including benzene, toluene, and xylenes (BTX), aromatic and non-aromatic naphtha range molecules, C11+ hydrocarbons, coke and char, and minor byproducts, mixed with the fluidization fluid. The vapor is passed to a solids separator 130 such as one or more cyclones where catalyst is separated and returned to the reactor and the vapors are sent to product recovery and separation (not shown).

Partially deactivated catalyst is continuously removed from the plastics pyrolysis reactor or from the regenerator (140). In an optional first step of the catalyst regeneration scheme, the used catalyst that has carbon deposits and minerals deposits on it is subjected to stripping/steaming in a stripper 120. In the optional stripping/steaming step, a flow of steam, inert gas, recycle gas, or some combination of these is passed over or through the spent catalyst and then added to the product stream (not shown). The optional stripping step may also be integrated into the plastics pyrolysis reactor.

The partially deactivated catalyst removed from the pyrolysis reactor 110 and optional stripper 120 is passed to a fluid bed oxidative regenerator 140. A portion of the deactivated and stripped catalyst may be discarded (“Deactivated Catalyst”). In the oxidative regenerator 140, the catalyst is exposed to an oxidizing fluidization gas flowing into the oxidative regenerator 140, usually air, diluted air, or a CO2 or steam-containing stream, or some combination of these, at a temperature sufficient to cause combustion of at least a portion of the coke in the oxidative regenerator. The oxidizing agent may originate from any source including, for example, a tank of oxygen, atmospheric air, or steam, or a portion of the vent gas from the regenerator, or some combination of these. In the oxidative regenerator, the catalyst is re-activated by reacting at least a portion of the coke deposited on the catalyst with the oxidizing agent. In some embodiments, the oxidative regenerator may comprise an optional purge stream, which may be used to purge coke, ash, and/or deactivated catalyst from the oxidative regenerator.

The oxidative catalyst regeneration can comprise more than one step of oxidation carried out in one or more than one reactor or chambers in the same reactor. If more than one oxidative regeneration step is employed the second oxidative regeneration is conducted at a temperature higher than the first oxidative regeneration step. Catalyst is continuously removed from the regenerator and at least a portion of the removed catalyst is fed to the catalyst wash step 150. A second portion of the oxidatively regenerated catalyst is sent to the catalytic pyrolysis reactor. The oxidatively regenerated catalyst and the oxidatively regenerated and washed catalyst portions may be fed to the catalytic pyrolysis reactor separately or together, alternatively the washed catalyst may be returned back to the regenerator A third portion of the oxidatively regenerated catalyst may be discarded.

The oxidative regenerator comprises a vent vapor stream which may include regeneration reaction products, residual oxidizing agents, and/or inert gases, and entrained catalyst particles. The vapor stream exiting the oxidative regeneration is sent to a solids separator 160, such as one or more cyclones, where entrained catalyst is recovered and at least a portion of the recovered catalyst may be returned to the oxidative regenerator, and a portion is sent to the catalytic pyrolysis reactor 110 or discarded. The flue gas vent stream from the regenerator may be passed through a catalytic exhaust gas cleanup system to further reduce the concentrations of CO and hydrocarbons to reduce emissions vented to the atmosphere. Portions of the vent stream may be recycled to the gas feed of the regenerator to control the heat release of the regeneration process (not shown). The oxidative regenerator may be fitted with a heat removal system such as a heat exchanger that produces steam, or other known heat removal system. Fuel and additional air may be introduced to the oxidative regenerator as an additional heat source. An external fired heater may be used to pre-heat the fluidization gas and oxidative agent before entering the regenerator. Methods for regenerating catalysts are well-known to those skilled in the art, for example, as described in Kirk-Othmer Encyclopedia of Chemical Technology (Online), Vol. 5, Hoboken, N.J.: Wiley-Interscience, 2001, pages 255-322.

An important feature of the oxidative regeneration process is that it is not required to rigorously remove all of the carbon on the catalyst since small amounts of coke may not significantly interfere with catalyst activity or selectivity. It also may be economically unattractive to remove the coke to such small quantities since the process would take longer and require longer catalyst residence time in the oxidative regenerator and larger volumes of regeneration gas etc. In some embodiments, the coke remaining on the catalyst can be 2.0%, 1.0%, 0.6%, 0.3%, 0.2%, 0.1%, 5000 ppm, 1000 ppm, or 250 ppm, or less, or from 500 ppm to 2.0%, 0.1% to 1.8%, 0.2% to 1.0%, or from 0.3 to 1.0% of the mass of the catalyst, based on the mass of coke remaining divided by the mass of catalyst plus coke; where the mass of coke remaining can be measured by elemental analysis or by completely burning off the coke; and where the initial mass of coke is measured after any degassing or steaming steps but before the oxidative regeneration process.

The oxidative regenerator may be of any suitable size for connection with the reactor or the solids separator. In addition, the regenerator may be operated at elevated temperatures in some cases (e.g., at least about 550° C., 575° C., 600° C., 625° C., 650° C., 675° C., or higher). The temperature in the regenerator may be controlled so that the time-averaged maximum temperature in the regenerator is less than 750° C., 725° C., 700° C., 675° C., or 650° C. The temperature in the regenerator may be controlled so that the transient maximum temperature in the regenerator is less than 750° C., 725° C., 700° C., 690° C., 660° C., or 650° C. The residence time of the catalyst in the regenerator may also be controlled using methods known by those skilled in the art, including those outlined above. In some instances, the mass flow rate of the catalyst through the regenerator will be coupled to the flow rate(s) in the reactor and/or solids separator in order to preserve the mass balance in the system and/or to control the heat balance of the system.

In some embodiments, the regenerated catalyst may exit the regenerator via an exit port. The regenerated catalyst may be recycled back to the reactor via a recycle stream. In some cases, catalyst may be lost from, or intentionally removed from, the system during operation. In some such and other cases, additional fresh makeup catalyst may be added to the system via a makeup stream. The regenerated and fresh catalyst may be fed to the reactor with the fluidization fluid via a recycle stream, although in other embodiments, the regenerated catalyst, the regenerated and washed catalyst, the makeup catalyst, and the fluidization fluid may be fed to the reactor via separate streams.

In one embodiment, at least a portion of the hot regenerated catalyst is separated from ash and catalyst fines before returning to a catalyst feed hopper. At least a portion of the hot regenerated catalyst and flue gas can be passed through a series of cyclones to separate the catalyst from the ash and catalyst fines; at least a portion of the oxidizing regeneration gas, after having reacted with the coke-contaminated catalyst, comprises flue gas from the regenerator; at least a portion of this hot flue gas can be used to heat the catalytic pyrolysis reactor. In some embodiments, at least a portion of the oxygen-containing regeneration gas comprises steam.

In this specification, where it is mentioned that contaminants (such as coke or minerals) are “deposited on” a catalyst, it of course includes the possibility that contaminants are deposited “in” a catalyst as well as “on” the catalyst. Typically, contaminants within pores of a catalyst are more difficult to remove and removal will take longer reaction times.

A preferred type of apparatus for oxidatively regenerating a coke-contaminated, fluidized catalyst, comprises in combination: (1) a combustion chamber into which the coke-contaminated catalytic pyrolysis catalyst may be introduced and contacted with regeneration gas; (2) a disengagement chamber located adjacent to and above (with respect to gravity) the combustion chamber and in communication therewith; (3) optional heat removal apparatus comprising conduits containing heat absorbing fluid positioned within the combustion chamber, the conduits being sealed with respect to the interior of the combustion chamber such that the heat-absorbing material is in indirect heat exchanging contact with the interior of the heat removal chamber; (4) a regeneration gas inlet port connecting with a lower portion of the combustion chamber for introducing at least a portion of the regeneration gas into the lower portion of the combustion chamber below the level of the catalyst bed; (5) a catalyst exit conduit positioned above the regeneration gas inlet, and (6) a regeneration gas outlet port that allows the flue gas to exit the regeneration reactor. A suitable reactor is a fluidized bed reactor such as a bubbling bed or circulating bed. Catalyst to be regenerated may be introduced into the regenerator above the bed or below the bed with the fluidization fluid.

### Catalyst Washing

Typically, the catalyst that is regenerated in a washing step is first regenerated in one or more oxidative regeneration stages (usually the oxidative regeneration comprises combustion) as described above. The oxidatively regenerated catalyst may then be treated to remove ash or catalyst fine particles or both, for example, by passage through one or more cyclone separators. Typically, it will be necessary to remove heat from the oxidatively regenerated catalyst prior to a washing step, and this heat is preferably at least partly recovered, for example, by preheating a fluidizing gas of the oxidative regeneration gas or of the biomass conversion reactor; likewise at least a portion of gas that is used to cool the oxidatively regenerated gas can be used as a fluidizing gas for the pyrolysis reactor or catalyst regenerator.

In the catalyst washing step at least a portion of said oxidatively regenerated catalyst is washed with a solution that at least partially removes the elements that have deposited on or in the catalyst. In this washing step of the catalyst regeneration, the catalyst is treated by washing with a liquid washing solution that at least partially removes the elements that have deposited thereon including but not limited to Ca, Mg, K, Na, Fe, Mn, S, Ti or combinations thereof. The solution can be any solution including water, acidic water, water with surfactants, water with multi-dentate ligands such as EDTA, polyvinylalcohol, oxalic acid, citric acid, or any other material that removes the mineral elements without damaging the catalyst structure or removing significant quantities of catalytically active elements or promoters or damaging the binder. Preferred solutions include mineral acids such as nitric acid, sulfuric acid, phosphoric acid, or some combination thereof, but not limited to these. Other washing solutions can be used including alcohols, ethers, organic acids, amines, supercritical CO2, or other materials, or any of these materials in water solution. The washing process can be operated at any temperature of at least 15, 20, 35, 50, or 90° C., or from −20 to 200, from 20 to 100, or from 25 to 75° C. depending on the nature of the mineral to be removed, the solvent, and the catalyst. The pH of the wash solution can be less than 5, 4, 3, 2, or 1, or from 0.01 to 5, 0.01 to 2.5, or 0.1 to 2. The washing could be done under pressure. The washing may be done under pressure, with absolute pressures of at least 1.1, 2, 4, or 10 bara, or from 0.5 to 10, 0.9 to 4, or from 1 to 2 bara.

In some embodiments the entire catalyst from an oxidative regeneration step is subjected to washing. In some other preferred embodiments, only a portion, such as 0.1 to 10%, 1 to 50%, 2 to 40%, 5 to 35%, or 10 to 30%, or less than 50%, 25%, 10%, 5%, or less than 1%, of the oxidatively regenerated catalyst is washed. The washing process need not be conducted after each time the catalyst passes through the reactor and is regenerated oxidatively, in some embodiments the washing could be used with catalyst that has passed through the reactor many times and oxidatively regenerated, i.e., washed only after 1 to 1000 cycles, or 2 to 500 cycles, or 10 to 200 cycles, or 10 to 100 cycles, or at least 10 cycles, or at least 50 cycles, or at least 100 cycles through the reactor and oxidative regenerator, thus making the process more efficient and saving energy. The washing process need not be conducted during the entire time the catalytic pyrolysis process is being conducted. The washing process can be conducted intermittently, i.e. the washing process can be conducted in a continuous manner for a time and then not conducted for a time. In some embodiments, a portion of the catalyst is separated from the remainder of the oxidatively regenerated catalyst and subjected to the washing step before being returned to the reactor. This would allow removal and treatment of a side stream to reduce the size of the equipment. It also maintains a portion, preferably the majority of the catalyst, at high temperature for recycle to the reactor; thus, reducing the requirement for reheating any washed catalyst. In some embodiments the catalyst is treated with an optional treatment step before the washing step such as sifting or air classification to remove fines and the lighter weight ash particles before washing the catalyst. Removal of the fines may facilitate the washing step by making it easier to separate the washed catalyst from the wash solution when the content of fines is reduced. In some embodiments, a portion of the fines removed before the washing step is returned to the reactor.

After washing is completed, the catalyst is rinsed with water, deionized water, distilled water, or an aqueous solution with less than 100 ppm of Ca and less than 100 ppm of Mg or other aqueous solution, and preferably recovered by filtration or centrifugation, which, in some embodiments, is followed by heating, for example, to remove water and residual wash solution materials (in the case where heating reaches high temperatures). Any process for solids separation can be used to remove the catalyst from the wash solution such as gravity filtration, centrifugal filtration, pressure filtration, vacuum filtration, or others. Solid-liquid separation processes are well known to those skilled in the art, such as in Solid-Liquid Separation (Fourth Edition), Ladislav Svarovsky, ed. 2001 Elsevier, incorporated herein by reference.

An important feature of the washing process is that it is not required to rigorously remove all of the mineral materials since small amounts of these materials, i.e., 1 ppm to 10% (based on total catalyst mass) may be useful to improve the catalyst life and stability or may not significantly interfere with catalyst activity, stability, or selectivity. It also may be economically unattractive to remove the minerals to such small quantities since the process would take longer and consume more solvents etc. Prior to the washing step, catalyst that has been used for the catalytic pyrolysis of plastics may contain 10%, 8%, 5%, 4.0%, 3.0%, or 2.0 mass % or more Ca, Mg, K, or Na or the sum of these depending on reaction conditions, length of exposure to biomass, and catalyst type, all when expressed as oxides. In some embodiments the Ca remaining on the catalyst after washing can be 2.0%, 1.0%, 0.6%, 0.3% 0.2%, 0.1%, 5000 ppm, 1000 ppm, or 250 ppm or less, or 0.0001 to 2.5%, 0.01 to 1.0%, or 0.2 to 2.0% when expressed as oxide. In some embodiments the Mg remaining on the catalyst after washing can be 2.0%, 1.0%, 0.6%, 0.3% 0.2%, 0.1%, 5000 ppm, 1000 ppm, or 250 ppm or less, or 0.0001 to 2.5%, 0.01 to 1.0%, or 0.2 to 0.5% when expressed as oxide. In some embodiments the K remaining on the catalyst after washing can be 2.0%, 1.0%, 0.6%, 0.3% 0.2%, 0.1%, 5000 ppm, 1000 ppm, or 250 ppm or less when expressed as oxide. In some embodiments the Ti or Fe remaining on the catalyst after washing can be 2.0%, 1.0%, 0.6%, 0.3% 0.2%, 0.1%, 5000 ppm, 1000 ppm, or 250 ppm or less when expressed as oxide. In some embodiments the S remaining on the catalyst after washing can be 2.0%, 1.0%, 0.6%, 0.3% 0.2%, 0.1%, 5000 ppm, 1000 ppm, or 250 ppm or less.

In some embodiments promoter elements such as Ga, Zn, Co, Fe, Cr, Cu, V, Ni, Mn, Ag, Na, P, Sn, Zr, Nb, Y, Ti, Ce, La, or combinations thereof, can optionally be re-introduced into the catalyst after (or simultaneous with) the extraction step. This could be done by impregnation with an aqueous solution or other means. In some embodiments, the active elements are introduced as components of a makeup catalyst.

The process of the present invention regenerates Brønsted acid sites on the catalyst to restore activity and selectivity for aromatics production. In some embodiments of this invention, the regeneration process restores the Brønsted acid sites (or Brønsted acid site density) to at least 70%, 75%, 80%, 100%, or at least 120%, or from 70% to 170%, 75% to 150%, or from 80% to 140% of the number of Brønsted acid sites (or site density) found in the fresh catalyst as determined in an IPA-TPD experiment. The process of the present invention can regenerate the Brønsted acid site density (mmol/kg) of the catalyst after washing to at least 30, 40, 50, 60, 70, 75, 80, 85, 90, 95, 100, or 110, or from 70 to 140, or from 80 to 120 mmol/kg as measured by an IPA-TGA adsorption experiment. The IPA-TPD experiment as described in the examples is the technique by which Brønsted acid sites are determined in the present invention.

In some embodiments, a catalyst wash unit comprises a Soxhlet extractor. In some other embodiments, the catalyst wash unit comprises a stirred tank, a rotary mixer, a sprayed conveyor belt, a slurry bubble column reactor, a Pachuca tank or a rotary disk in which the catalyst is treated in several stages of washing. Apparatus and methods for contacting solutions with catalysts are known to those skilled in the art.

### Feed Pretreatment

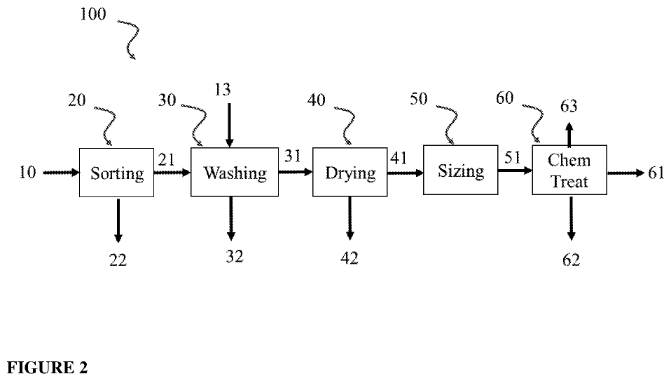

In some embodiments the catalyst pyrolysis process may include a feed pretreatment process. FIG. 2 presents one embodiment of a pretreatment process 100 for pretreating waste plastic to make it suitable for catalytic upgrading. A mixture of plastics is introduced into an optional preliminary sorting system 20 that removes undesirable materials and rejects them in stream 22 and passes the useful materials 21 to a washing process 30. The sorting is often done manually or by any of a number of automated processes that include items such as screens and pickers or robotic mechanisms that are well known in the art. The undesirable materials 22 may include items such as metal, concrete, dirt, wood, mineral matter, glass, or other material that is not readily processed along with waste plastics. In the washing step 30, a solvent, water, or aqueous solution 13 is admixed with the solid waste plastic, optionally agitated, and optionally heated, and the washed solids 31 are separated from the waste wash solution 32, rinsed with an aqueous solution (not shown), and passed to a drying unit 40. In some embodiments, the rinse can be conducted in the same vessel as the wash. In the dryer 40 moisture and volatile solvents are removed by exposure to a flowing gas stream, optionally heated or by condensation and passing out as a liquid 42. The dried material 41 is passed to a sizing unit 50. In the sizing unit, the plastics are shredded by any of a range of cutting devices and large particles that do not pass through a sizing screen 52 are discarded or recycled to the preliminary sorting system 20, and the sized materials 51 are passed to a thermal pretreatment unit 60. In the thermal pretreatment unit 60, the material is heated to melt at least a portion of the plastic and drive off volatile off-gas products 63 such as HCl, HBr, HI, NH3, CO2, or other volatile decomposition products. Optionally, solid co-reactants (not shown), such as CaO, Ca(OH)2, CaCO3, MgO, hydrotalcites, activated carbon, or zeolites, or some combination of these, that trap or remove undesirable components can be fed to thermal treatment reactor 60. The thermal pretreatment unit 60 may comprise one or more static mixers in which the molten mixture may be passed through a static mixing device to increase the homogeneity of the mixture. As part of the thermal pretreatment unit 60, the molten mixture may be passed through a screen or other device to remove solids, added co-reactants, or fragments of material 62 that do not melt under the conditions of the process. The pretreatment process produces a stream 61 of pretreated material that can be cooled and chopped to an appropriate size for use in catalytic pyrolysis or kept hot and fed directly to a catalytic pyrolysis process.

The various units of the pretreatment process, i.e., 20, 30, 40, 50, and 60, can be re-arranged to suit the needs of the particular waste plastic mixture, the catalytic pyrolysis process, or other processes, or existing infrastructure, and may comprise any combination of these elements, or others as needed. In some cases, not all of these units will be needed, and some can be omitted.

In embodiments wherein a solid co-reactant is fed to the thermal treatment reactor the separated solid co-reactant materials 62 are optionally transferred to a combustion regenerator (not shown) wherein the carbonaceous materials are reacted with air and at least a portion of the hot solid co-reactant material is returned to the thermal treatment reactor. In one embodiment of the invention the hot flue gas exiting the solid co-reactant regenerator is passed to a catalyst heater to heat the catalyst for the catalytic pyrolysis reactor or vented.

The pretreatment process may include an additional pelleting or other particle shaping process step to produce waste plastic particles into cylindrical or near spherical shapes that are readily handled (not shown). A pelleting process may involve feeding plastic waste materials such as stream 61 in FIG. 2 to an extruder where they are heated to form a molten mixture that is passed through an orifice. The resulting extrudate may be cooled and chopped or sliced into the desired size for transport and handling and feed to the pyrolytic upgrading process. An alternative pelleting process may involve stamping pellets from the solidified mixed plastic. Alternatively, suitable pellets of plastic may be produced by compressing the plastic mixture at an elevated temperature until enough softening occurs that the material binds together, and then cooling and chopping, cutting, or shredding the resulting mass to produce the desired size range of particles.

### Catalytic Pyrolysis

The catalytic pyrolysis reactor comprises any suitable reactor known to those skilled in the art. For example, in some instances, the reactor may comprise a continuously stirred tank reactor (CSTR), a batch reactor, a semi-batch reactor, or a fixed bed catalytic reactor, among others. In some cases, the reactor comprises a fluidized bed reactor, e.g., a circulating fluidized bed reactor, a moving bed reactor such as a riser reactor, or a bubbling bed reactor. Fluidized bed reactors may, in some cases, provide improved mixing of the catalyst and/or hydrocarbonaceous material during pyrolysis and/or subsequent reactions, which may lead to enhanced control over the reaction products formed. The use of fluidized bed reactors may also lead to improved heat transfer within the reactor. In addition, improved mixing in a fluidized bed reactor may lead to a reduction of the amount of coke adhered to the catalyst, resulting in reduced deactivation of the catalyst in some cases. Throughout this specification, various compositions are referred to as process streams; however, it should be understood that the processes could also be conducted in batch mode. Examples of suitable apparatus and process conditions for catalytic pyrolysis are described in U.S. Pat. No. 8,277,643 of Huber et al. and in U.S. Pat. No. 9,169,442 of Huber et al. which are incorporated herein by reference.

The temperatures in the catalytic pyrolysis reactor where catalyst is present (which may be measured by one or more thermocouples in contact with a catalyst bed) are preferably in the range of 500 to 700° C., 520 to 600° C., 500 to 575° C., 550 to 600° C., 575 to 625° C., or 540 to 580° C. The catalytic pyrolysis is conducted in the absence of any added metals other than metals present in or on the catalyst. The residence time of gases or feed molecules in the catalytic pyrolysis reactor is at least 0.1 seconds, 0.3, 0.5, 1, 2, 3, 5, or 10 seconds, or in the range of 0.3 to 30, or 2 to 15, or 5 to 15, or 2 to 5, 10 to 30, or 0.5 to 10 seconds. The pressure in the catalytic pyrolysis reactor may be at least 1.1, 2, 4, or 10 bara, or from 0.5 to 10, 0.9 to 4, or from 1 to 2 bara.

In some embodiments, at least a portion of the olefins in the fluid hydrocarbon product stream is separated from the rest of the product stream to produce a recycle stream, comprising at least a portion of the separated olefins in the recycle stream.

Suitable methods for separating and recovering aromatics from other fluid hydrocarbon products are known to those of ordinary skill in the art. For example, aromatics can be separated from other fluid hydrocarbon products by cooling the product stream, or a portion thereof, to a suitable temperature and a second separator that separates at least a portion of the aromatics from other gaseous products (e.g., gaseous aromatics, CO2, CO, etc.) and from an aqueous product stream. The methods and/or conditions used to perform the separation can depend upon the relative amounts and types of compounds present in the fluid hydrocarbon product stream, and one of ordinary skill in the art will be capable of selecting a method and the conditions suitable to achieve a given separation given the guidance provided herein.

In one set of embodiments, catalyst removed from the catalytic pyrolysis reactor may contain significant quantities of organic compounds including aromatics and olefins. Prior to the step of oxidatively regenerating the catalyst, the catalyst removed from the catalytic pyrolysis reactor may be stripped of volatile materials by passing a stream comprising steam through the catalyst and collecting the products. The steam-containing stream that is used to strip the organics can be fed to the reactor or it can be directed to the separation train or can otherwise be combined with product streams for recovery of the valuable organic compounds.

It should be understood that, while the set of embodiments described above includes a reactor, solids separator, regenerator, catalyst wash unit, condenser, etc., not all embodiments will involve the use of these elements. For example, in some embodiments, the feed stream may be fed to a catalytic reactor, reacted, and the reaction products may be collected directly from the reactor and cooled without the use of a dedicated condenser. In some instances, the product may be fed to a quench tower to which is fed a cooling fluid, preferably a liquid, most preferably a recycle stream, along with the product stream to cool and condense the products. In some instances, while a dryer, sizing system, solids separator, regenerator, catalyst wash unit, condenser, and/or compressor may be used as part of the process, one or more of these elements may comprise separate units not fluidically and/or integrally connected to the reactor. In other embodiments, one or more of the dryer, sizing system, solids separator, regenerator, condenser, and/or compressor may be absent. In some embodiments, the desired reaction product(s) (e.g., liquid aromatic hydrocarbons, olefin hydrocarbons, gaseous products, etc.) may be recovered at any point in the production process (e.g., after passage through the reactor, after separation, after condensation, etc.).

The invention is generally applicable to any plastics pyrolysis process. Preferably, the plastic feedstock comprises a solid hydrocarbonaceous material. The plastic feedstock may comprise, for example, any one or combination of the plastics sources that are mentioned in the Glossary section.

The pyrolysis reactor comprises a solid catalyst for catalytic pyrolysis. The type of reactor and the type of solid catalyst (if present) can be generally of the type known for the conversion of plastic to fluid hydrocarbonaceous streams. Examples of suitable apparatus and process conditions for catalytic pyrolysis include those described in U.S. Pat. No. 8,277,643 by Huber et al., which is incorporated herein by reference. Conditions for catalytic pyrolysis of plastic can be selected from any one or any combination of the following features (which are not intended to limit the broader aspects of the invention): a zeolite catalyst, a ZSM-5 catalyst; a zeolite catalyst comprising one or more of the following metals: titanium, vanadium, chromium, manganese, iron, cobalt, nickel, copper, zinc, gallium, platinum, palladium, silver, tin, phosphorus, sodium, potassium, magnesium, calcium, tungsten, zirconium, cerium, lanthanum, and combinations thereof; a fluidized bed, circulating bed, or riser reactor; an operating temperature in the range of 3000 to 1000° C.; and/or a solid catalyst-to-plastic mass ratio of between 0.1 and 20. In some preferred embodiments, the catalyst comprises zinc, gallium, iron, tin, chromium, lanthanum, or some combination of these.

Preferred catalysts comprise solid phosphoric acid (such as phosphoric acid on kieselguhr) or zeolites ZSM5, ZSM11, ZSM12, ZSM22, ZSM23, ZSM35, ZSM49, and MCM56. Regenerated catalysts can be used, including regenerated ZSM-5 from the catalytic pyrolysis process. A preferred temperature range is 400 to 600° C., preferably 450 to 575° C.; although higher temperatures could be used. Pressures preferably are in the range of 1 atm to 20 bara, preferably 1-5 bara. The reaction can be conducted in various types of reactors, but preferably is conducted in a fluidized bed reactor.

### Waste Plastics Upgrading Process

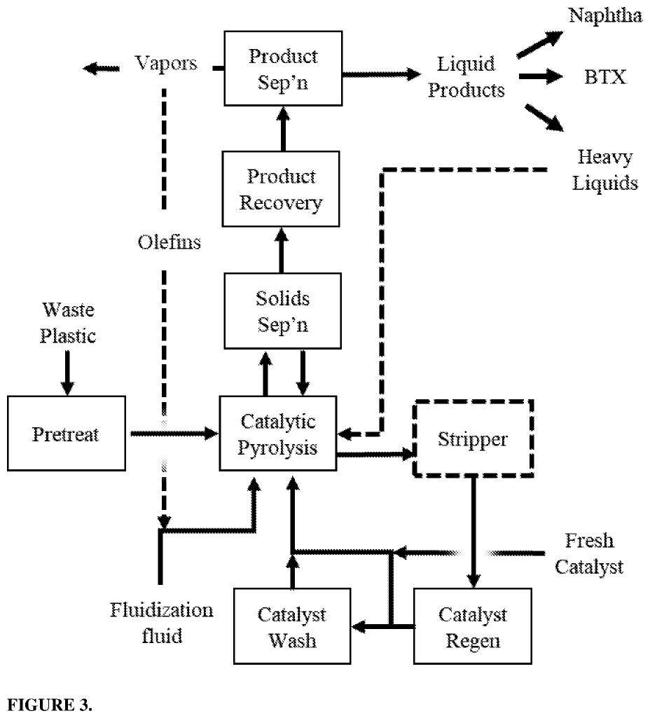

FIG. 3 depicts an embodiment of a process for pretreating and upgrading plastic mixtures. A mixture of waste plastics is introduced into a feed pretreatment system as depicted in FIG. 2, which may be one of a number of such pretreatment facilities that prepare the plastic mixture for introduction into the process. The pretreated plastic mixture may be in the form of pellets, irregular particles, or may be passed to the catalytic pyrolysis reactor as a melt. The pretreated plastic mixture is passed to the fluid bed catalytic pyrolysis reactor that comprises a plastics upgrading catalyst. A fluidization fluid is fed to the catalytic pyrolysis reactor and a product stream is removed and sent to a solids separator, product recovery, and product separation. Entrained catalyst is removed in the solids separation system and returned to the catalytic pyrolysis reactor while the products are sent to recovery and separation.

Catalyst is continuously withdrawn from the catalytic pyrolysis reactor and optionally sent to a stripper (dashed line) where it is steamed or stripped of organics that are sent to product separation (not shown). The catalyst is sent to a regenerator for oxidative regeneration. A portion of the oxidatively regenerated catalyst is washed to remove Ca and other contaminants and returned to the catalytic pyrolysis reactor either in combination with, or separate from, the balance of the oxidatively regenerated catalyst. A portion of the catalyst can be removed at any place in the process and fresh catalyst can be introduced along with the regenerated catalyst, the washed catalyst, or both, or separately. In product recovery the hot pyrolyzed vapor stream is quenched to separate the condensable products (liquids) from the vapor products and fixed gases. The liquid products are separated into various streams including naphtha, BTX, and one or more heavy liquid streams. Optionally a portion of the heavy liquids is recycled to the catalytic pyrolysis reactor (dashed line).

Optionally, an olefin-containing stream is separated from the vapor product stream and recycled to the catalytic pyrolysis reactor (dashed line), optionally in combination with the fluidization fluid. Optionally, the olefin-containing stream separated from the vapor product stream is sent to a product purification process to produce an olefin product stream or streams. The balance of the vapor stream is combusted to generate heat for the process or combusted to generate electricity or sent to flare. In some embodiments, a stream of hydrogen is separated from the vapors for use elsewhere in the process or as a product.

In the desorption curve of an isopropyl amine temperature programmed desorption (IPA-TPD) experiment, the sharp desorption at 270-380° C. is assigned to IPA decomposition into propylene and NH3 occurring on the Brønsted acid sites. The peak area under the desorption curve measured from 270 to 380° C. is used for quantifying the number of Brønsted acid sites for a particular sample. The desorption curve measured from 130-270° C. is assigned to weak acid sites. Whilst not wishing to be bound by theory, it has been observed that the Brønsted acid sites on the catalyst appear to be active for the preferred conversion of plastic to aromatics, whereas the weak acid sites are not as important. The process of the present invention regenerates Brønsted acid sites on the catalyst to restore activity and selectivity for aromatics production. In some embodiments of this invention the regeneration process restores the Brønsted acid sites to at least 70%, 75%, 80%, 100%, 105%, or at least 110%, or from 70% to 170%, 75% to 150%, or from 80% to 120% of the number of Brønsted acid sites found in the fresh catalyst as determined in an IPA-TPD experiment.

### EXAMPLES

### Activity Test Procedure

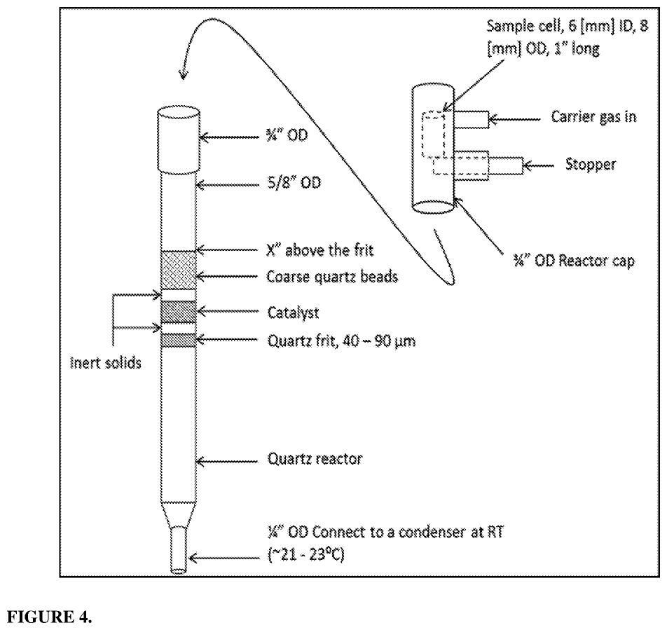

Catalyst activity tests were conducted in a drop-tube reactor. The drop-tube reactor comprises a quartz reactor tube (ACE Glass) containing a quartz frit (40-90 μm) fused into the center of the tube. FIG. 4 shows the configuration of the drop-tube reactor. A sample cell (10 mm OD, 8 mm ID, 25 mm length, quartz, made by TGP) is used to contain the feedstock using two pieces of quartz wool (TGP). As illustrated in FIG. 4, the sample cell was placed in a reactor cap (borosilicate, ACE Glass) and was held by a stopper (¼ inch (6 mm) aluminum rod, McMaster). The reactor cap and the quartz reactor were then assembled and installed onto the fixed-bed reactor system. The bottom of the reactor was connected to a condenser (borosilicate) filled with perforated stainless steel packing (ACE Glass) immersed in an ice-water bath (0° C.). A heating mantle was applied between the reactor bottom and the condenser top to prevent any condensation before the condenser. During the reaction, the heating mantle was set at 210° C.

In the reactor, a small sample of the catalyst being tested (1.5 g) was placed on top of the quartz frit. Feedstock (100 mg for each run) was sealed in a sample cell with quartz wool. The catalyst/feedstock weight ratio was about 15. Prior to dropping the contents of the sample cell into the reactor, the catalyst was heated to 584° C. (ramping rate=30° C./min) and calcined under 100 mL/min air flow for 20 min. The reactor system was then purged with helium flow at 75 mL/min for 20 min to remove air and purge the gas collection lines. With the helium flow at 75 mL/min the sample cell was dropped into the reactor by pulling out the stopper rod to initiate the reaction.

A hold period of 10 min allowed the reaction to complete. Gas products, consisting mostly of permanent gases and C1-C3 olefins and paraffins were collected in a gas bag. Liquid products (mostly C4+) were collected in the condenser. After the reaction period, the temperature was increased to 650° C. without gas flow. Solid products, including coke and char remaining in the reactor, were then burned at 650° C. for 10 min under 50 mL/min air flow. The gas products during burning were collected in a second gas bag. An additional 3 mL of solvent was added to the condenser to extract any products remaining on the top of the condenser. All of the liquid in the condenser was then transferred to a 20 mL sample vial. A weighed amount of internal standard (dioxane, typically 3000-5000 mg, Sigma-Aldrich) was added to the sample vial. The condenser was washed with acetone and dried in a drying oven. It is noted that a small amount of liquid was retained in the condenser due to holdup on the packing. Therefore, the weight of the condenser with and without liquid products was measured to obtain the total amount of liquid products. Liquid samples were analyzed by a GC-FID (gas chromatograph with flame ionization detector from Shimadzu 2010Plus) for hydrocarbons and oxygenates. Gas bag samples were analyzed using an Agilent GC 7890B gas chromatograph.

### Examples 1 Through 3

A sample of the fresh, unused ZSM-5 catalyst was designated Catalyst A.

A sample of an oxidatively regenerated catalyst that was used for plastics upgrading for 86 hours was designated Catalyst B.

A 10 g sample of used regenerated catalyst (Catalyst B) was placed on the frit of a glass fritted funnel. A 50 g portion of 0.1N H2SO4 was added and the catalyst was soaked for about 40 minutes, then was filtered. The washing and filtering were repeated once. A sample of about 50 g of DI (deionized) water was added and the catalyst was allowed to soak for 40 minutes and then filtered. The rinse with water was repeated once and the solid was filtered and dried in a drying oven at 110° C. overnight. The sample was designated Catalyst C.

The 3 catalysts were analyzed by ICP and the results appear in Table 1.

Brønsted Acid site Density (BAD) measurement by temperature programmed desorption (TPD) of isopropyl amine (IPA). For the IPA-TPD experiments, a thermogravimetric analysis (TGA) instrument (Shimadzu TGA-50) is adjusted to read zero with an empty platinum sample cell. The sample cell is then filled with a sample of catalyst powder (10-30 mg). The catalyst is pre-treated at 500° C. under 50 mL/min N2. It is then cooled to 120 C under a 50 mL/min flow of N2. Isopropylamine (IPA) is fed into the TGA chamber at this temperature by flowing a 2nd portion of N2 gas (<10 mL/min) through a bubbler filled with liquid IPA while monitoring the weight of the sample. The feed of IPA is stopped when the catalyst is saturated as indicated by no more weight increase. The flows of N2 are maintained through the chamber, but bypassing the IPA bubbler, for an additional 120 min to remove weakly adsorbed IPA. The TGA chamber is then heated up to 700° C. at a ramping rate of 10° C./min to obtain desorption curves, and the weight is monitored as a function of temperature.

In the desorption curve, the sharp desorption at 270-380° C. is assigned to IPA decomposition into propylene and NH3 occurring on the Brønsted acid sites. The peak area under the desorption curve measured from 270 to 380° C. is used for quantifying the number of Brønsted acid sites for a particular sample. The desorption curve measured from 130-270° C. is assigned to weak acid sites.

Total Surface Area (TSA) and Zeolite Surface Area (ZSA) were measured by nitrogen adsorption.

TABLE 1
Analytical results of Examples 1 through 3.

| | | | Na | Ca | K | TSA | ZSA | BAD |
|---|---|---|---|---|---|---|---|---|
| Example | Catalyst | Condition | Wt % | Wt % | Wt % | m²/g | m²/g | mmol/kg |
| 1 | A | Fresh | 0.34 | 0.02 | 0.02 | 140 | 114 | 81 |
| 2 | B | Used | 0.38 | 0.77 | 0.05 | 139 | 105 | 77 |
| 3 | C | Used and | 0.34 | 0.18 | 0.02 | 158 | 117 | 85 |
| | | Washed | | | | | | |

TSA = total surface area;
ZSA = Zeolite surface area;
BAD = Brønsted acid site density

The results in Table 1 show that the washing step removed 77% of the calcium on the catalyst, the zeolite surface area was restored to at least its value in the fresh catalyst, and the Brønsted acid site density was restored to at least its value in the fresh catalyst.

TABLE 2
Drop-tube test results for Examples 1 through 3.

| | | | | Yield | Yield |
|---|---|---|---|---|---|
| | | | | Change w | compared to |
| Example | 1 | 2 | 3 | washing | fresh catalyst |
| Catalyst | A | B | C | % | % |
| | Yield, wt % | | | | |
| BTX + Olefins | 54.48 | 57.78 | 56.83 | −2% | 4% |
| BTX | 29.52 | 21.42 | 29.54 | 38% | 0% |
| Olefins | 24.96 | 36.36 | 27.29 | −25% | 9% |
| Paraffins | 5.27 | 4.98 | 4.9 | −2% | −7% |
| CO2 | 4.6 | 4.92 | 5.29 | 8% | 15% |
| Coke | 4.43 | 3.91 | 4.45 | 14% | 0% |
| Other aromatics | 4.35 | 9.62 | 3.63 | −62% | −17% |
| H2 | 1.16 | 0.87 | 1.5 | 72% | 29% |

The results in Table 2 demonstrate that the BTX yield was reduced by 27% (from 29.52 to 21.42 wt %) by use for plastics upgrading and that the BTX yield was fully restored by washing. The results in Table 2 show that the overall yield of BTX+ olefins was almost unchanged by the exposure to plastics pyrolysis, but the relative amounts of BTX and olefins were changed such that more olefins were produced with the used catalyst. The results show that washing the used catalyst restored the relative amounts of BTX and olefins to almost the same ratio as they were produced by the fresh catalyst. The results show that the BTX yield was the same in the washed used catalyst as in the fresh catalyst and the olefins yield was slightly increased in the washed used catalyst compared to the fresh catalyst. The results in Table 2 show that the used catalyst produced more ‘other aromatics’ than a fresh catalyst or the washed used catalyst. The ‘other aromatics’ include naphthalene and other aromatics with 10 or more carbon atoms.

### Examples 4 Through 10

Examples 4 through 10 were conducted to determine how well the washing technique could restore activity to catalysts that had been tested for longer times and processed more plastic feed in a pilot scale reactor.

Plastics upgrading was conducted in a large pilot scale unit used to demonstrate Plas-TCat™ and produce product samples. The reactor system includes a bubbling fluid bed of catalyst and a regenerator. Catalyst is constantly drained from the bubbling bed and sent to the regenerator where it is regenerated by reaction with a stream of air and returned to the reactor. The vapor product stream is sent through a series of cyclones to remove fine particles that are returned to the reactor, and the products are condensed from the vapors.

The total inventory of catalyst in the system was 160 kg of ZSM-5, with 40 kg in the reactor at any one time. Plastic is injected into the fluid bed continuously at a rate of 8 kg/hr to achieve a weight hourly space velocity (WHSV) of 0.2 hr-1 based on the catalyst mass in the reactor. The temperature of the fluid bed was maintained in the range of 540-570° C., and the temperature of the regenerator was maintained at 650° C.

The plastic mixture used in the process had the nominal composition of 38.0% PE, 16.0% PP, 17.0% PS, 10.0% PET, 2.0% biomass, 56.8% nylon, 3.4% PC (polycarbonate), 3.4% PU (polyurethane), 1.7% ABS (acrylonitrile-butadiene-styrene), 1.7% MMA (methyl methacrylate), obtained from a local recycling facility. The calcium and magnesium contents of the feed mixture were measured and spanned the range from 3813 to 7564 ppm of Ca, with an average of 5334+/−728 ppm Ca, and a range from 448 to 666 ppm of Mg, with an average of 510+/−48 ppm Mg over the course of the 798 hours of operation. Samples of catalyst removed from the system after oxidative regeneration were taken periodically. A portion was analyzed without washing and a second portion was washed, analyzed by ICP and XRF, and both washed and unwashed samples were tested in the drop-tube reactor.

Washed samples were prepared for activity testing in the drop tube reactor as follows: a 10 g sample of the regenerated, unwashed catalyst is dispersed into 50 g of 0.1N H2S04 solution, shaken for 5 minutes, then filtered and the filtrate was collected. A 50 g portion of de-ionized (DI) water is added to the wet cake and shaken for about 20 seconds, then filtered and filtrate collected. The washed wet cake is dried overnight to provide the washed solid sample. The twice-washed sample for Example 10 was prepared by using a 5-g sample of the once-washed material from Example 9 and repeating the procedure with 25 g of the wash solution and rinse solutions.

TABLE 3
Calcium contents of unwashed and washed catalysts
measured by XRF, expressed as wt % CaO.

| | | CaO, Wt % | | | % of Ca |
|---|---|---|---|---|---|
| | Hours | | | CaO | on catalyst |
| | on | Before | After | removed by | removed by |
| Example | stream | Washing | Washing | washing | washing |
| Fresh | 0 | 0.035 | — | — | — |
| 4 | 16 | 0.218 | 0.092 | 0.126 | 57.8% |
| 5 | 65 | 0.435 | 0.164 | 0.271 | 62.3% |
| 6 | 90 | 0.864 | 0.396 | 0.468 | 54.2% |
| 7 | 222 | 1.338 | 0.721 | 0.617 | 46.1% |
| 8 | 566 | 2.174 | 1.273 | 0.901 | 41.4% |
| 9 | 785 | 3.031 | 1.198 | 1.833 | 60.5% |
| | | | | Average | 53.7% |

The results in Table 3 show the deposition of Ca on the catalyst increases steadily with time on stream and that the washing step removes Ca from the catalyst. The results show that about half of the Ca on the catalyst is removed in each washing step independent of the total amount of Ca on the catalyst, i.e. when more Ca is on the catalyst the washing removes more Ca. The washing removes at least 40% of the Ca in every case. This result shows that the washing of the catalyst is effective for a catalyst that has been on stream for many hours and has processed large amounts of plastics.

Waste plastics typically contain small concentrations of Mg unless Mg is part of dolomite that is used as a filler. The removal of Mg was evaluated along with Ca in the catalyst washing experiments.

TABLE 4
Magnesium contents of unwashed and washed catalysts
measured by XRF, expressed as wt % MgO.

| | | MgO, Wt % | | | % Mg on |
|---|---|---|---|---|---|
| | Hours | | | MgO | catalyst |
| | on | Before | After | removed by | removed by |
| Example | stream | Washing | Washing | washing | washing |
| Fresh | 0 | 0.106 | na | na | na |
| 4 | 16 | 0.090 | 0.072 | 0.018 | 20.0% |
| 5 | 65 | 0.101 | 0.071 | 0.03 | 29.7% |
| 6 | 90 | 0.159 | 0.114 | 0.045 | 28.3% |
| 7 | 222 | 0.170 | 0.151 | 0.019 | 11.2% |
| 8 | 566 | 0.253 | 0.220 | 0.033 | 13.0% |
| 9 | 785 | 0.274 | 0.188 | 0.086 | 31.4% |
| | | | | Average | 22.3% |

The results in Table 4 show the deposition of Mg on the catalyst increases steadily with time on stream and that the washing step removes Mg from the catalyst. The results show that on average 22.3% of the Mg on the catalyst is removed in each washing step independent of the total amount of Mg on the catalyst, i.e. when more Mg is on the catalyst the washing removes more Mg. The washing removes at least 11% of the Mg in every case. This result shows that the washing of the catalyst is effective for removing Mg from a catalyst that has been on stream for many hours and has processed large amounts of plastics.

TABLE 5
Potassium contents of unwashed and washed catalysts
measured by XRF, expressed as wt % K2O.

| | | K2O, Wt % | | | % of K on |
|---|---|---|---|---|---|
| | Hours | | | K2O | catalyst |
| | on | Before | After | removed by | removed by |
| Example | stream | Washing | Washing | washing | washing |
| Fresh | 0 | 0.028 | | 0 | |
| 4 | 16 | 0.031 | 0.016 | 0.015 | 48.4% |
| 5 | 65 | 0.039 | 0.009 | 0.03 | 76.9% |
| 6 | 90 | 0.058 | 0.03 | 0.028 | 48.3% |
| 7 | 222 | 0.080 | 0.046 | 0.034 | 42.5% |
| 8 | 566 | 0.150 | 0.088 | 0.062 | 41.3% |
| 9 | 785 | 0.165 | 0.109 | 0.056 | 33.9% |
| | | | | Average0 | 48.6% |

The results in Table 5 show the deposition of K on the catalyst increases steadily with time on stream and that the washing step removes K from the catalyst. The results show that less than half of the K on the catalyst is removed in each washing step independent of the total amount of K on the catalyst, i.e. when more K is on the catalyst the washing removes more K. The washing removes at least 30% of the K in every case. This result shows that the washing of the catalyst is effective for a catalyst that has been on stream for many hours and has processed large amounts of plastics. A comparison of the results of Tables 3 and 5 show that the washing process of the present invention on average removes more a larger portion of Ca than K.

TABLE 6
The sum of calcium, magnesium, and potassium contents, and the sum of calcium,
magnesium, and sodium contents of unwashed and washed catalysts measured
by XRF, when expressed as oxides, i.e. CaO, MgO, K2O, and Na2O wt %.

| | Hours | CaO + MgO + K2O | | | CaO + MgO + Na2O | | |
|---|---|---|---|---|---|---|---|
| | on | Before | After | % | Before | After | % |
| Example | stream | Washing | Washing | Removal | Washing | Washing | Removal |
| Fresh | 0 | 0.169 | na | | 0.601 | na | |
| 4 | 16 | 0.339 | 0.180 | 46.9% | 0.808 | 0.564 | 30.2% |
| 5 | 65 | 0.575 | 0.244 | 57.6% | 1.026 | 0.665 | 35.2% |
| 6 | 90 | 1.081 | 0.540 | 50.0% | 1.563 | 0.940 | 39.9% |
| 7 | 222 | 1.588 | 0.918 | 42.2% | 2.068 | 1.302 | 37.0% |
| 8 | 566 | 2.577 | 1.581 | 38.6% | 3.017 | 2.033 | 32.6% |
| 9 | 785 | 3.470 | 1.495 | 56.9% | 3.915 | 1.916 | 51.1% |

| | | |
|---|---|---|
| Average | 48.7% | 37.7% |

The results in Table 6 show that a single washing step removes Ca, Mg, and K together from the catalyst and that the average removal of the sum of Ca, Mg, and K together is 48.7% by mass as oxides. The results in Table 6 show that a single washing step removes Ca, Mg, and Na together from the catalyst and the average removal of the sum of Ca, Mg, and Na together is 37.7% by mass as oxides.

TABLE 7
The sum of calcium, magnesium, potassium, and sodium contents,
of unwashed and washed catalysts measured by XRF, expressed
as oxides, i.e. CaO, MgO, K2O, and Na2O wt %.

| | |
|---|---|
| Hours | CaO + MgO + K2O + Na2O |

| | on | Before | After | |
|---|---|---|---|---|
| Example | stream | Washing | Washing | % Removal |
| Fresh | 0 | 0.629 | na | |
| 4 | 16 | 0.839 | 0.580 | 30.9% |
| 5 | 65 | 1.065 | 0.674 | 36.7% |
| 6 | 90 | 1.621 | 0.970 | 40.2% |
| 7 | 222 | 2.148 | 1.348 | 37.2% |
| 8 | 566 | 3.167 | 2.121 | 33.0% |
| 9 | 785 | 4.080 | 2.025 | 50.4% |
| Average | | | | 38.1% |

The results in Table 7 show that a single washing step removes Ca, Mg, K, and Na together from the catalyst and the average removal of the sum of Ca, Mg, K, and Na together is 37.7% by mass as oxides.

TABLE 8
The sum of silica, alumina, and titania contents of
unwashed and washed catalysts measured by XRF, expressed
as the sum of SiO2, Al2O3, and TiO2 wt %.

| | Hours on | | | After Wash % |
|---|---|---|---|---|
| Example | stream | Before Wash | After wash | different from Fresh |
| Fresh | 0 | 83.77 | | |
| 4 | 16 | 83.57 | 84.90 | 1.35% |
| 5 | 65 | 83.27 | 84.48 | 0.85% |
| 6 | 90 | 83.21 | 84.07 | 0.36% |
| 7 | 222 | 82.73 | 83.74 | −0.04% |
| 8 | 566 | 81.15 | 82.53 | −1.48% |
| 9 | 785 | 79.44 | 83.00 | −0.92% |
| Average | | 82.23 | 83.79 | 0.00% |

As shown by the results in Table 8 the washing process does not significantly damage the zeolite structure or change its composition. The total amount of the structural components of the zeolite, i.e., silica, alumina, and titania, remain almost unchanged through 785 hours of operation as shown by the amount of these materials remaining in the catalyst. The increase in the fraction of these materials upon washing is due to the removal of CaO, MgO, and other soluble metal oxides (Na₂O, K₂O, etc.) such that the fraction of SiO₂+Al₂O₃+TiO₂ is increased on a relative basis. The results in Table 8 show that the sum of the structural materials SiO₂, Al₂O₃, and TiO₂ is almost unchanged after being on stream for many hours and having processed large amounts of plastics.

Activity tests were conducted on the used catalysts both before washing and after washing in drop tube tests as described above.

TABLE 9
Effect of Washing on Yield of Aromatics + Olefins and Aromatics.

| | | Yield Aromatics + Olefins, Wt % | | | Yield Aromatics, Wt % | | |
|---|---|---|---|---|---|---|---|
| | Hours | | | % Increase | | | % Increase |
| | on | | | due to | | | due to |
| Example | stream | Unwashed | Washed | Washing | Unwashed | Washed | Washing |
| Fresh | 0 | 59.1 | na | na | 51.1 | na | |
| 4 | 16 | 64.0 | 70.1 | 9.6% | 32.1 | 50.0 | 56.0% |
| 5 | 65 | 66.0 | 68.3 | 3.5% | 29.7 | 44.0 | 48.0% |
| 6 | 90 | 60.8 | 69.5 | 14.2% | 24.6 | 41.5 | 68.6% |
| 7 | 222 | 56.8 | 64.5 | 13.6% | 21.7 | 35.5 | 63.5% |
| 8 | 566 | 52.7 | 67.4 | 27.9% | 19.2 | 32.5 | 69.5% |
| 9 | 785 | 58.9 | 65.5 | 11.1% | 21.4 | 32.9 | 53.5% |
| 10 | 785 2x | | 68.6 | *4.7% | | 37.3 | *13.4% |
| | wash | | | | | | |

*The comparison is between the sample that had been washed twice (Example 10) and the sample that had been washed one time (Example 9), showing the effect of the second wash step.

The average increase in Aromatics+Olefins yield with 1 washing is calculated to be 13.3%. The average increase in Aromatics yield with 1 washing is calculated to be 59.8%.

The results in Table 9 surprisingly show that the yield of aromatics plus olefins is greater with the used, washed catalyst than with the fresh catalyst. The results in Table 9 show that the yield of aromatics and olefins is significantly increased with the washed catalyst compared to the unwashed used catalyst. The results in Table 9 show that the yield of aromatics is significantly increased with the washed catalyst compared to the unwashed used catalyst. The result of Example 10 in Table 9 shows that a second washing further increases the yield of aromatics, and also increases the sum of aromatics and olefins. These results show that washing the catalyst is effective at increasing aromatics and the sum of aromatics and olefins yields for a catalyst that has been on stream for many hours and has processed large amounts of plastics.

TABLE 10
Effect of Washing on Yield of BTX and Xylenes

| | | | | | Yield Xylenes, Wt % | | |
|---|---|---|---|---|---|---|---|
| | | Yield BTX, Wt % | | % Increase | | | % Increase |
| | Hours on | Not | | due to | Not | | due to |
| | stream | washed | Washed | Washing | washed | Washed | Washing |
| Fresh | 0 | 45.1 | na | na | 0.9 | na | na |
| 4 | 16 | 26.2 | 44.9 | 71.4% | 3.4 | 5.7 | 66.9% |
| 5 | 65 | 23.1 | 39.9 | 72.4% | 2.9 | 5.0 | 71.8% |
| 6 | 90 | 17.0 | 37.2 | 118.5% | 0.9 | 4.4 | 407.9% |
| 7 | 222 | 13.9 | 31.8 | 129.2% | 1.4 | 3.8 | 173.7% |
| 8 | 566 | 9.3 | 26.9 | 188.9% | 0.5 | 3.4 | 608.8% |
| 9 | 785 | 9.9 | 27.1 | 172.4% | 1.4 | 3.3 | 137.4% |
| 10 | 785 2x | | 32.6 | *20.4% | | 4.0 | *19.8% |
| | washed | | | | | | |

*The comparison is between the sample that had been washed twice (Example 10) and the sample that had been washed one time (Example 9), showing the effect of the second wash step.

The average increase in BTX yield with 1 washing is calculated to be 125%. The average increase in Xylenes yield with 1 washing is calculated to be 244%.

The results in Table 10 show that the yield of BTX is greatly increased with washing the catalyst compared to the unwashed used catalyst. The results in Table 10 show that the yield of xylenes is greatly increased with washing the catalyst compared to the unwashed used catalyst. The results in Table 10 surprisingly show that the yield of xylenes is greater with the used, washed catalyst than with the fresh catalyst. The result of Example 10 in Table 10 shows that a second washing increases the yield of BTX and xylenes. These results show that washing the catalyst is effective at increasing BTX and xylenes yields for a catalyst that has been on stream for many hours and has processed large amounts of plastics.

TABLE 11
Selectivity to Xylenes among BTX Products.

| | Hours | | | | |
|---|---|---|---|---|---|
| | on | Xylenes Selectivity in BTX | | Selectivity BTX in Aromatics | |
| | Stream | Unwashed | Washed | Unwashed | Washed |
| Fresh | 0 | 2% | | 88% | |
| 4 | 16 | 13.0% | 12.7% | 82% | 90% |
| 5 | 65 | 12.6% | 12.5% | 78% | 91% |
| 6 | 90 | 5.1% | 11.9% | 69% | 90% |
| 7 | 222 | 10.1% | 12.1% | 64% | 90% |
| 8 | 566 | 5.2% | 12.7% | 49% | 83% |
| 9 | 785 | 14.2% | 12.4% | 46% | 82% |
| 10 | 785 2 X wash | | 12.3% | | 88% |

The data in Table 11 show that washing the catalyst in all cases returns the selectivity to xylenes among BTX produced to the selectivity established in the early hours of the process, which is much greater than the selectivity for xylenes provided by the fresh catalyst. The data in Table 11 show that washing the catalyst returns the selectivity to BTX among aromatics produced to the selectivity established in the early hours of the process, which is nearly the same as the selectivity to BTX provided by the fresh catalyst. Example 10 in Table 11 shows that a second washing further improves the selectivity to BTX to the selectivity produced by the fresh catalyst after 785 hours on stream and when the catalyst has processed an amount of feed that is 39 times the mass of catalyst.

TABLE 12
Effect of Washing on Brønsted Acid Site Density.

| | | BAD, mmol/kg | | | |
|---|---|---|---|---|---|
| | Hours on | Not | | % Increase | |
| Example | Stream | washed | Washed | with washing | % Fresh |
| Fresh | | 115 | | | 100% |
| 4 | 16 | na | 106 | | 92% |
| 5 | 65 | 83 | 104 | 25% | 90% |
| 6 | 90 | 73 | 97 | 33% | 84% |
| 7 | 222 | 69 | 94 | 36% | 82% |
| 8 | 566 | 59 | 87 | 47% | 76% |
| 9 | 785 | 60 | 91 | 52% | 79% |
| 10 | 785 2x washed | | 152 | *67% | 132% |

*The comparison is between the sample that had been washed twice (Example 10) and the sample that had been washed one time (Example 9), showing the effect of the second wash step.

The results in Table 12 show that the exposure to plastics pyrolysis conditions reduces the BAD of the catalyst significantly. The results in Table 12 show that washing the used regenerated catalyst increases the BAD compared to the unwashed catalyst. The results in Table 12 show that washing the used regenerated catalyst increases the BAD to at least 75% of the BAD of the fresh catalyst with one wash cycle and to greater than the BAD of the fresh catalyst with a second wash cycle. The results in Table 12 show that the BAD of the catalyst can be restored to nearly its fresh value after the catalyst has been on stream more than 780 hours and has processed more plastics than 39 times the mass of catalyst.

TABLE 13
Running Feed Total and Total Feed/Catalyst mass ratio.

| | Hours on | Total Feed from | Total Feed/ |
|---|---|---|---|
| Example | stream | Start of Run, kg | Catalyst Ratio* |
| Ref | 0 | 0 | 0 |
| 4 | 16 | 127 | 0.79 |
| 5 | 65 | 518 | 3.24 |
| 6 | 90 | 717 | 4.48 |
| 7 | 222 | 1773 | 11.08 |
| 8 | 566 | 4525 | 28.28 |
| 9 | 785 | 6281 | 39.26 |

*Assumes 160 kg of catalyst in the unit.

Table 13 presents the totals for the catalytic pyrolysis pilot experiment including the hours on stream, amount of plastics feed during up to that time, and the ratio of total feed/catalyst mass up to that time on stream. Table 13 shows that all of the conclusions about the catalyst and the catalyst washing above can be interpreted in terms of the ratio of total feed the catalyst has processed in the same manner as with the time on stream, i.e. dependence of the washing and performance results on total mass of feed processed per mass of catalyst is the same as dependence on time on stream.

1. A method of regenerating a catalyst used in the catalytic pyrolysis of plastics, comprising:
providing a catalyst that has been used to catalyze a catalytic pyrolysis of plastics process;
oxidatively regenerating the catalyst;
washing at least a portion of the catalyst with a liquid wash solution;
rinsing the washed catalyst with an aqueous liquid solution;
separating the catalyst from the rinse solution; and
returning at least a portion of the separated catalyst to the process for the catalytic pyrolysis of plastics.

2. The method of claim 1 wherein the catalyst is a zeolite,
wherein the wash solution comprises sulfuric acid, and
wherein the washed and rinsed catalyst has at least 40% less calcium, or at least 10% less magnesium, or at least 30% less potassium, or some combination of these than does the unwashed used catalyst wherein the percentage is based on the weight of liquid-free catalyst.

3. (canceled)

4. The method of claim 1 wherein the wash solution comprises at least 90%, 95%, or 99% water.

5. The method of claim 1 wherein the wash solution used to wash the catalyst comprises phosphoric acid, sulfuric acid, nitric acid, or some combination of these.

6-9. (canceled)

10. The method of claim 1 wherein the washed catalyst has at least 10%, 20%, 50%, or 80% less calcium, or from 10 to 95%, 10 to 90%, 10 to 80%, or 10 to 50% less calcium by weight than does the catalyst prior to the washing step, where the mass % is measured for catalysts after calcination.

11-12. (canceled)

13. The method of claim 1 wherein the washed catalyst has at least 70%, 80%, 100%, or at least 120%, or less than 150%, 140%, or 135%, or from 70% to 150%, or from 80% to 140% of the Brønsted acid site density (mmol/kg) as compared to a freshly prepared catalyst as determined by IPA-TPD analysis.

14. The method of claim 1 wherein the Brønsted acid site density (mmol/kg) of the catalyst increases at least 15%, 20%, 25%, 30%, or 40%, or from 1% to 75%, 10% to 70%, or 20% to 60% after washing compared to the Brønsted acid site density of the catalyst before washing.

15. The method of claim 1 wherein the Brønsted acid site density (mmol/kg) of the catalyst after washing is at least 70, 75, 80, 85, 90, 95, 100, or 110 or from 70 to 140, or from 80 to 120 mmol/kg as measured by an IPA-TGA adsorption experiment.

16. (canceled)

17. The method of claim 1 wherein the BTX wt % yield increases by at least 50%, 70%, 100%, 150%, or 170%, or from 50% to 300%, 60% to 250%, or 70% to 200% after washing the catalyst compared to the BTX yield for the unwashed catalyst, as tested by reacting plastic with a sample of catalyst in a fixed bed reactor at a temperature of at least 500° C.

18-21. (canceled)

22. The method of claim 1 comprising treating the washed catalyst with a solution that adds one or more metals or other elements chosen from among P, Fe, Ga, Zn, or La or some combination thereof to the catalyst.

23-25. (canceled)

26. The method of claim 1 wherein the catalyst comprises ZSM-5.

27. (canceled)

28. The method of claim 1 wherein the catalyst comprises a promoter chosen from among nickel, palladium, platinum, titanium, vanadium chromium, manganese, iron, cobalt, zinc, copper, gallium, phosphorus, the rare earth elements, i.e., elements 57-71, cerium, zirconium, or any of their oxides or some combination thereof.

29-31. (canceled)

32. The method of claim 1 wherein the K, Ca, or Mg, contents or their sum in the catalyst prior to washing is in the range from 0.1% to 10%, 0.2% to 8%, 0.5% to 5%, or 1% to 5% by mass when expressed as oxides.

33-36. (canceled)

37. The method of claim 1 wherein the wash process is continuous and conducted with countercurrent flow of catalyst and wash solution in one vessel, or in multiple vessels wherein the catalyst and wash solutions move between vessels in a counter current fashion.

38. The method of claim 1 wherein the rinse solution is water, deionized water, distilled water, or an aqueous solution with less than 100 ppm of Ca and less than 100 ppm of Mg, or some combination thereof.

39. The method of claim 1 wherein the selectivity for xylenes among BTX products is greater than 5, 8, 10, 11, or 12% by mass after washing the catalyst that has been on stream for at least 10 hours or the catalyst has processed a mass of plastic that is at least 0.79 times the mass of catalyst in the reactor as tested by adding plastic to a sample of catalyst in a fixed bed reactor at a temperature of at least 550° C.

40. A method of converting plastics to hydrocarbon products, comprising:
feeding plastics into a reactor fitted with a catalyst;
pyrolyzing the plastics in the reactor in the presence of the catalyst that catalyzes the pyrolysis reaction which results in coke-contaminated catalyst;
removing a portion of the catalyst from the reactor;
oxidatively regenerating the catalyst;
washing at least a portion of the catalyst with a liquid wash solution;
rinsing the washed catalyst with an aqueous solution;
separating the catalyst from the rinse solution;
returning at least a portion of the washed catalyst to the process for the catalytic pyrolysis of plastics; and
returning at least a portion of the unwashed regenerated catalyst to the process for the catalytic pyrolysis of plastics.

41. The method of claim 40 wherein the catalyst comprises a zeolite, the wash solution comprises sulfuric acid, and wherein the washed and rinsed catalyst has at least 40% less calcium, or at least 10% less magnesium, or at least 30% less potassium, or some combination of these than does the unwashed used catalyst wherein the percentage is based on the weight of liquid-free catalyst.

42-56. (canceled)

57. The method of claim 40 wherein the BTX yield after washing is at least 25%, 30%, 35%, or 40%, or from 25% to 50%, 25% to 45%, or 25% to 40% by mass based on plastic feed as tested by reacting plastic with a sample of catalyst in a fixed bed reactor at a temperature of at least 500° C.

58-59. (canceled)

60. A catalyst that has been used in the catalytic pyrolysis of plastics wherein one or more of the elements Ca, Mg, K, or Na deposited on the catalyst during the catalytic pyrolysis reaction has been at least partially removed by washing with a liquid wash solution and rinsing with an aqueous solution, wherein the deposited elements comprise at least 0.1% of the total mass of catalyst.

61-73. (canceled)
